(19) United States
(12) Patent Application Publication
(10) Pub. No.: US 2015/0187223 A1
(43) Pub. Date: Jul. 2, 2015

(54) DEIDENTIFIED ACCESS OF INSTRUCTIONAL CONTENT

(71) Applicant: Pearson Education, Inc., Upper Saddle River, NJ (US)

(72) Inventors: Vishal Kapoor, Iowa City, IA (US); Cole Joseph Cecil, Coralville, IA (US); David Earl Rodgers, Iowa City, IA (US)

(73) Assignee: Pearson Education, Inc., Upper Saddle River, NJ (US)

(21) Appl. No.: 14/144,437

(22) Filed: Dec. 30, 2013

(51) Int. Cl. G09B 7/00

(52) U.S. Cl. CPC G09B 7/00

(57) ABSTRACT

Generally, embodiments of the invention are directed to methods, computer readable medium, servers, and systems for deidentified access of instructional content. The deidentified access is permitted with the use of an identifier that uniquely indicates an outcome of a diagnostic test, the coding of the identifier obscures unaided human interpretation of the outcome, and the identifier uniquely identifies instructional content for remediating performance on the diagnostic test.

### BACKGROUND

There are many resources to improve a student's performance on a test, including live classroom instruction. However, when the student is placed in a class, the level of the class is identified for others, so that others may deduce how well the student performed on an entrance exam for the class. For example, the student that is placed in Algebra 1A obviously performed worse on an entrance exam than the student placed in Algebra 2B. Similarly, the student who scored 1600 on their SAT obviously performed better on the exam than the student that scored 1200. For some students, it may be embarrassing to advertise the results of these tests, especially when the results of the test are meant to help improve the performance of the student and/or provide the student with the appropriate instructional content.

### BRIEF DESCRIPTION OF THE DRAWINGS

FIG. 1 illustrates an example architecture for implementing deidentified access of instructional content described herein that includes a testing server, remediation server, network, and user device, according to at least one example;

FIG. 2 illustrates an example architecture of a testing server with one or more data stores, according to at least one example;

FIG. 3 illustrates an example architecture of a remediation server with one or more data stores, according to at least one example;

FIGS. 4A-4B and 5A-5B illustrate examples of data that are stored in the diagnostic data store, according to at least one example;

FIG. 6 illustrates an example encryption process of an identifier, according to at least one example;

FIG. 7 illustrates an example graphical user interface for displaying a diagnostic test, according to at least one example;

FIG. 8 illustrates an example graphical user interface for displaying a diagnostic review, according to at least one example;

FIG. 9 illustrates an example graphical user interface for accessing instructional content, according to at least one example;

FIG. 10 illustrates an example graphical user interface for displaying instructional content, according to at least one example;

FIG. 11 illustrates an illustrative flow for implementing deidentified access of instructional content described herein, according to at least one example;

FIG. 12 illustrates an illustrative flow for implementing deidentified access of instructional content described herein, according to at least one example;

FIG. 13 illustrates an illustrative flow for implementing deidentified access of instructional content described herein, according to at least one example;

FIG. 14 illustrates an illustrative flow for implementing deidentified access of instructional content described herein, according to at least one example;

FIG. 15 illustrates an example environment for implementing deidentified access of instructional content described herein, according to at least one example; and

FIG. 16 illustrates an example special-purpose computer system, according to at least one example.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

In one embodiment, the present disclosure provides an apparatus for deidentified access of instructional content for testing. This apparatus includes, for example, a processor and a memory device including instructions that, when executed by the processor, cause the processor to receive a plurality of test answers to a plurality of test sections in a diagnostic test. The diagnostic test diagnoses the performance of a user. The plurality of test sections in the diagnostic test includes a first section of a diagnostic test and a second section of a diagnostic test. The plurality of test answers corresponds with the user interacting with the diagnostic test. The plurality of test answers includes a first set of test answers and a second set of test answers. The first set of test answers corresponds to the first section of the diagnostic test, and the second set of test answers corresponds to the second section of the diagnostic test. The processor may also be configured to identify a plurality of correct answers in a key. The plurality of correct answers in the key includes a first section of correct answers and a second section of correct answers. The first section of correct answers corresponds with the first section of the diagnostic test, and the second section of correct answers corresponds with the second section of the diagnostic test.

The processor is also configured to compare the first set of test answers with the first section of correct answers in the key. The processor is also configured to determine a first outcome on the first section of the diagnostic test based in part on the comparison of the first set of test answers. The first outcome identifies one or more correct responses provided in the first section of the diagnostic test. The processor is also configured to compare the second set of test answers with the second section of correct answers in the key. The processor is also configured to determine a second outcome on the second section of the diagnostic test based in part on the comparison of the second set of test answers. The second outcome identifies one or more correct responses provided in the second section of the diagnostic test. The processor is also configured to generate an identifier associated with the user of the diagnostic test. The identifier uniquely indicates the first outcome of the first section of the diagnostic test and the second outcome of the second section of the diagnostic test. The coding of the identifier obscures unaided human interpretation of the first outcome and the second outcome. The identifier uniquely identifies a plurality of instructional content for remediating performance on the diagnostic test. The processor is also configured to transmit the identifier. The identifier uniquely identifies a plurality of instructional content for remediating performance on the diagnostic test. The apparatus also includes an interface. The interface is configured to transmit the identifier via a network.

In one embodiment, the present disclosure provides a method for deidentified access of instructional content for testing. The method includes, for example, receiving a plurality of test answers to a plurality of test sections in a diagnostic test. The method also includes identifying a plurality of correct answers in a key. The method also includes comparing the first set of test answers with the first section of correct answers in the key. The method also includes determining a first outcome on the first section of the diagnostic test based in part on the comparison of the first set of test answers. The method also includes comparing the second set of test answers with the second section of correct answers in the key. The method also includes determining a second outcome on the first section of the diagnostic test based in part on the comparison of the second set of test answers. The method also includes generating an identifier associated with the user of the diagnostic test. Additionally, the method includes transmitting the identifier.

In one embodiment, the present disclosure provides a method for deidentified access of instructional content for testing. The method includes determining a plurality of instructional content. The plurality of instructional content includes a first section of instructional content and a second section of instructional content. The plurality of instructional content corresponding with a diagnostic test. The diagnostic test diagnosing performance of a user. The diagnostic test including a first section of the diagnostic test and a second section of the diagnostic test. The method also includes receiving an identifier associated with the user of the diagnostic test. The identifier uniquely indicates a first outcome of the first section of the diagnostic test and a second outcome of the second section of the diagnostic test. The coding of the identifier obscures unaided human interpretation of the first outcome and the second outcome. The identifier uniquely identifies the plurality of instructional content for remediating performance on the diagnostic test.

The method also includes identifying a plurality of remediation levels in association with the identifier. The plurality of remediation levels identifying the remediation needed for the user based in part on the performance on the diagnostic test. The plurality of remediation levels include a first level of remediation and a second level of remediation. The first level of remediation corresponds with the first section of the diagnostic test. The second level of remediation corresponds with the second section of the diagnostic test. The method also includes determining the first section of instructional content in association with the first level of remediation. The first section of instructional content is identified for remediating performance on the first section of the diagnostic test. The method also includes determining the second section of instructional content in association with the second level of remediation. The second section of instructional content is identified for remediating performance on the second section of the diagnostic test. The method also includes displaying the plurality of instructional content.

In an illustrative example, a student finishes taking a diagnostic test. The diagnostic test includes 10 questions in various sections of the diagnostic test, including algebra (e.g., word problems, computation with decimals) and reading comprehension. The answers to each of the questions are compared with an answer key. The system determines that the student needs help with word problems, but not computation with decimals, based on the comparison, and generates an identifier that allows the student to access instructional content for remediating the student's performance in word problems. The identifier indicates the student's performance, but the coding of the identifier obscures unaided human interpretation of that performance. When the student submits the identifier to the server, the server determines what remediation level is needed in association with the identifier and displays the instructional content for that remediation level.

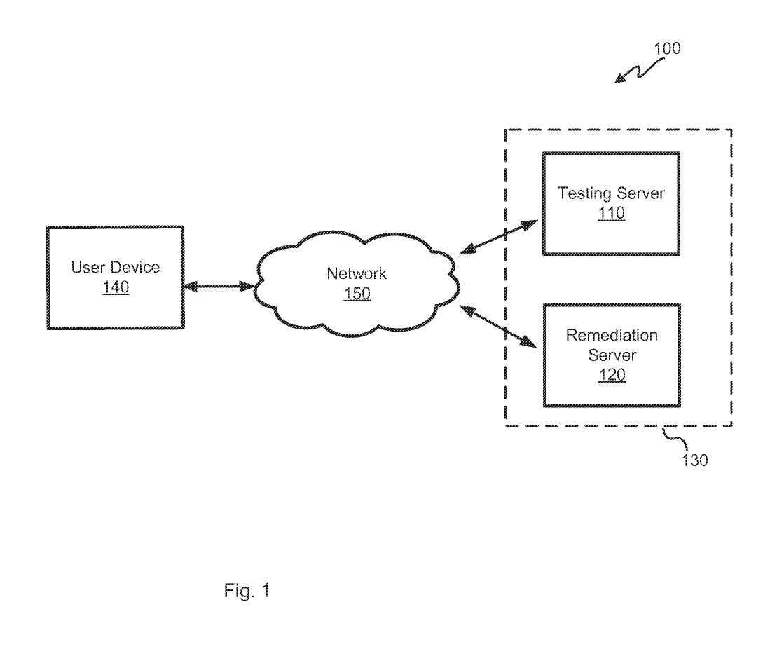

With reference now to FIG. 1, a block diagram of one embodiment of a system for implementing deidentified access of instructional content is shown. The system 100 includes example architecture, including a testing server 110, remediation server 120, optionally combined testing and remediation server 130, user device 140, and network 150.

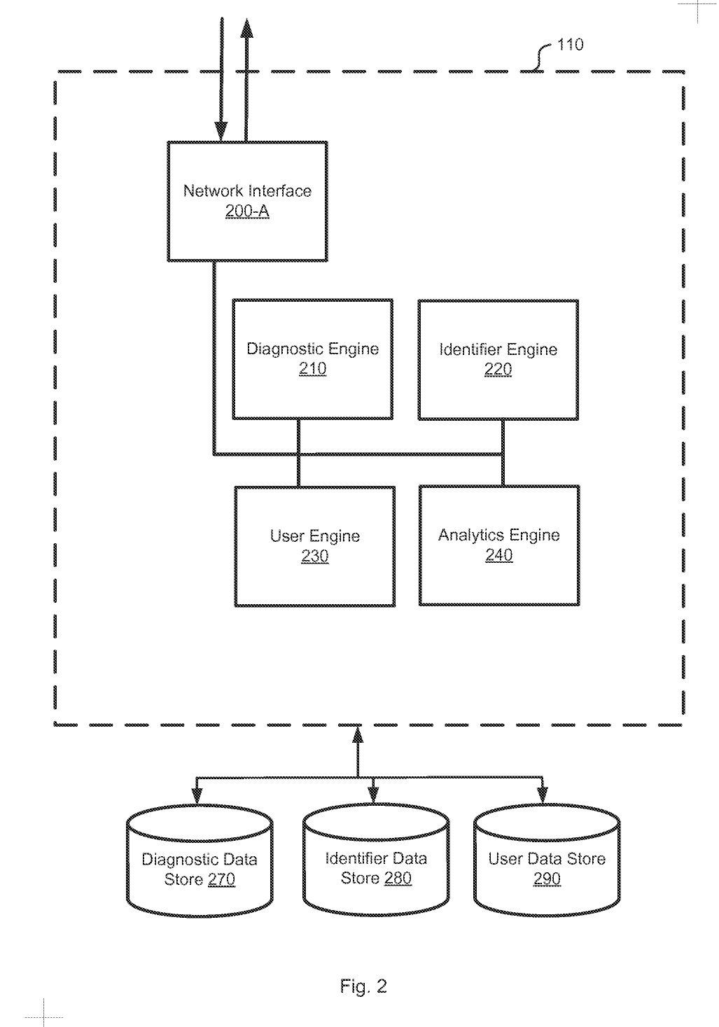

The system 100 includes a testing server 110. The testing server 110 is configured to provide the diagnostic test, which can diagnose the performance of the user on one or more test sections in the diagnostic test. The testing server 110 is also configured to identify an outcome of the user on the diagnostic test by comparing the user's test answers with the correct answers in a key. The testing server 110 is also configured to generate an identifier associated with the user of the diagnostic test. The testing server 110 is also configured to transmit the identifier that uniquely identifies the instructional content for remediating performance on the diagnostic test. Details and features of one type of testing server 110 are provided in association with FIG. 2.

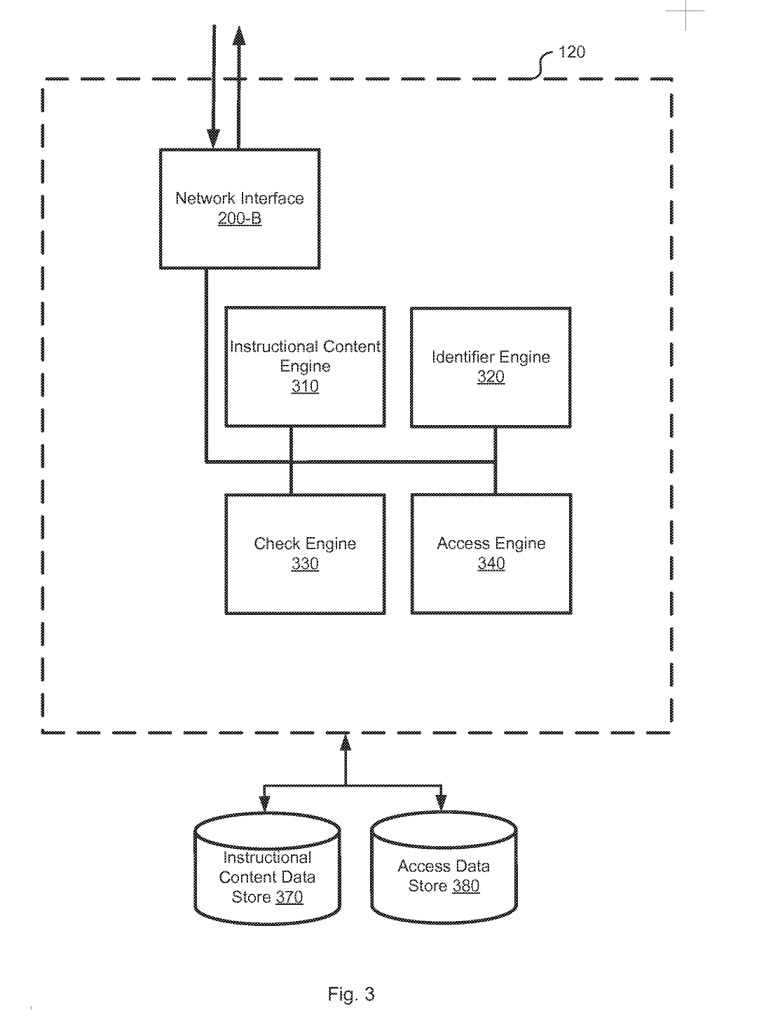

The system 100 also includes a remediation server 120. The remediation server 120 is configured to provide the instructional content to help remediate performance on the diagnostic test. The remediation server 120 is also configured to receive an identifier associated with the user of a diagnostic test and identify the instructional content in association with that identifier. The remediation server 120 is also configured to display the instructional content. Details and features of one type of remediation server 120 are provided in association with FIG. 3.

The system 100 may optionally include a combined testing and remediation server 130. The combined testing and remediation server 130 provides the functionality of the testing server 110 and the remediation server 120, but as a single or combined server. For example, the combined testing and remediation server 130 can be configured to provide a diagnostic test, identify an outcome of the user on the diagnostic test, generate an identifier associated with the user of the diagnostic test, transmit the identifier, provide the instructional content, receive an identifier associated with the user, identify the instructional content in association with that identifier, and display the instructional content. Hereinafter, the use of testing server 110 and combined testing and remediation server 130, or the use of remediation server 120 and combined testing and remediation server 130 can be referred to interchangeably. Details and features of one type of combined testing and remediation server 130 are provided in association with FIGS. 2 and 3.

The system 100 also includes a user device 140. The user device 140 may correspond with a credential, authentication identifier, device identifier, user identifier, identifier associated with the user of a diagnostic test, user name, payment information, or other information that allows the user of the device to access, manage, receive, generate, or otherwise interact with the diagnostic test and/or instructional content. The user device 140 may be used by businesses or other entities, including a learning institution, student, user, or administrator.

In some embodiments, the user device 140 is configured to display instructional content or a diagnostic test for a user. For example, the user interacts with the diagnostic test provided by the testing server 110 by operating a user device 140. The user device transmits the user's responses as test answers to the testing server 110, so that the server can generate the identifier. In another example, the user device 140 receives instructional content from the remediation server 120. The user device 140 is configured to display the instructional content for the user that has been identified for remediating performance on a particular section of the diagnostic test.

In some embodiments, for example, the user device 140 provides a credential to a testing server 110, so that the testing server 110 can correlate the user of the device or the user device itself with a certified identity. In some embodiments, the credential is used to keep track of the interaction between the user device and the testing server 110, or the interaction between the user device 140 and the remediation server 120.

The system 100 also includes a network 150. The network 150 includes wired or wireless connections to one or more intranets (e.g., located within the geographic area of the testing server 110, remediation server 120, combined testing and remediation server 130), one or more internets (e.g., located within and outside of the geographic area of the testing server 110, remediation server 120, combined testing and remediation server 130), public or private channels, communication tunnels between one or more servers, or other means of communication. The network 150 may include encryption or other form of protection to help secure the diagnostic test, answers, instructional content, credentials, and other information that is transmitted and received between the testing server 110, remediation server 120, combined testing and remediation server 130, or user device 140. One or more devices may communicate, transmit, or receive information through the network 150, including the testing server 110, remediation server 120, optionally combined testing and remediation server 130, or user device 140.

With reference now to FIG. 2, a block diagram of one embodiment of a testing server for implementing deidentified access of instructional content is shown. For example, the testing server 110 includes a network interface 200-A, diagnostic engine 210, identifier engine 220, user engine 230, analytics engine 240, and one or more data stores, including a diagnostic data store 270, identifier data store 280, and user data store 290.

As depicted in FIG. 2, the testing server 110 includes a network interface 200 (herein shown as 200-A). The network interface 200 allows the devices, networks, and other systems to access the other components of the system 100. The network interface 200 includes features configured to send and receive information, including, for example, an antenna, a modem, a transmitter, receiver, or any other feature that can send and receive information. The network interface 200 can communicate via telephone, cable, fiber-optic, and other wired communication network. In some embodiments, the network interface 200 communicates via cellular networks, WLAN (wireless local area networking) networks, or any other wireless network.

The network interface 200 can also be configured to send and receive data. In some embodiments, the network interface 200 sends a diagnostic test to a user device, sends a plurality of test sections to a user device, receives test answers that correspond to the sections of the diagnostic test, or receives correct answers in a key. For example, the user device 140 provides test answers that correspond to the sections of the diagnostic test, which are received via the network interface 200.

The testing server 110 also includes a diagnostic engine 210. The diagnostic engine 210 can be configured to identify a diagnostic test, which can diagnose the performance of a user. The user may include a student or any other individual or user device that interacts with the diagnostic test. The diagnostic test may include a plurality of sections of the diagnostic test, including a first section and second section. The sections of the diagnostic test may include one or more subjects, including algebra, arithmetic, reading comprehension, sentence skills, or other subjects. In some embodiments, the sections of the diagnostic test are provided in other formats, including difficulty levels (e.g., one section is low difficulty, one section is high difficulty), test types (e.g., logic, reading, games), nested sets of questions (e.g., one prompt for seven questions), and timeframes (e.g., one section corresponds to one hour or day, a second section corresponds to a different hour or day). In some examples, the sections of the diagnostic test can represent particular strands or portions of the diagnostic test. For example, when the diagnostic test includes algebra problems, the strands or portions of the diagnostic test include word problems, computation with decimals, main ideas, or other strands or portions.

The diagnostic engine 210 can also be configured to receive and/or identify a key. The key may include a set of correct answers for a particular diagnostic test, including a first section of correct answers and a second section of correct answers. For example, the diagnostic engine 210 receives a plurality of test answers to a plurality of test sections in a diagnostic test and the plurality of test answers correspond with the user interacting with the diagnostic test. The plurality of test answers can include a first set of test answers and a second set of test answers, such that the first set of test answers corresponds to the first section of the diagnostic test, and the second set of test answers corresponds to the second section of the diagnostic test.

The diagnostic engine 210 can also be configured to identify a plurality of correct answers in the key, including a first section of correct answers and a second section of correct answers. The correct answers in the key may correspond with various sections of the diagnostic test. For example, the first section of correct answers corresponds with the first section of the diagnostic test and the second section of correct answers corresponds with the second section of the diagnostic test. In another example, the correct answers may include “C” for question 1, “D” for question 2, and “No” for question 3.

The diagnostic engine 210 can also be configured to compare the test answers from the user with sections of correct answers. For example, the test answers from the student may include “A” for question 1, “C” for question 2, and “Yes” for question 3. The correct answers from the key may include “C” for question 1, “D” for question 2, and “No” for question 3. In this instance, the diagnostic engine 210 determines that the student scored “0,” received 0% correct or 100% incorrect, or any other method of grading the test answers in comparison with the correct answers.

The diagnostic engine 210 can also be configured to determine an outcome for a particular section of the diagnostic test. For example, the determination includes a first outcome on the first section of the diagnostic test based in part on the comparison of the first set of test answers. The first outcome can identify one or more correct responses provided in the first section of the diagnostic test (e.g., 50% correct, answers 4 and 5 are correct). In another example, the determination includes a second outcome on the second section of the diagnostic test based in part on the comparison of the second set of test answers.

The testing server 110 also includes an identifier engine 220. The identifier engine 220 can be configured to generate an identifier associated with the user of the diagnostic test. The identifier can include one or more alphanumeric characters, including alphabetic characters, digits, and/or symbols that are associated with instructional content, remediation levels, one or more outcomes associated with sections of the diagnostic test, one or more users associated with the identifier, sections of the diagnostic test, check portion (e.g., digit), access credentials, or other information. For example, when an identifier is “1AGCJ-5ABEFH-6,” the identifier identifies two sections of the diagnostic test (e.g., 1 for arithmetic and 5 for general math, 1 for word problems and 5 for computation with decimals, 1 for one stand of a diagnostic test and 5 for a different strand of a diagnostic test), a plurality of remediation levels (e.g., “A” for a low score in the fractions section of diagnostic arithmetic, “G” for a medium score in the division section of diagnostic arithmetic, “C” for a low score in the percentages section of diagnostic arithmetic), and a check portion (e.g., by translating the identifier to a numeric value to help confirm that the identifier was provided correctly to a remediation server or webpage).

In some embodiments, the identifier uniquely indicates the first outcome of the first section of the diagnostic test and the second outcome of the second section of the diagnostic test. The outcome identifies one or more correct responses provided in a particular section of the diagnostic test. For example, the outcome includes a “low” score in the fractions section of the diagnostic test, a “medium” score in the division section of arithmetic section of the diagnostic test, and a “low” score in the percentages section of diagnostic test. In another example, the outcome includes 50% correct or answers 4 and 5 are correct.

The identifier can uniquely indicate the outcome by including identifier portion(s) with the identifier. For example, an identifier of “1AGCJ” incorporates five identifier portions, including “1,” “A,” “G,” “C,” and “J,” where each character, digit, or symbol is an identifier portion. In another example, an identifier of “1A-2J” incorporates two identifier portions, including “A” and “J,” where “A” indicates a low score on the fractions section of the arithmetic section (e.g., “1”) and “J” indicates a low score on the main concepts section of the reading comprehension section (e.g., “2”). In another example, an identifier of “1A-2J” incorporates two identifier portions, including “A” and “J,” where “A” indicates a low score on the fractions section, portion, or strand of algebra (e.g., “1”) and “J” indicates a low score on the main concepts section, portion, or strand of reading comprehension (e.g., “2”).

In some embodiments, the coding of the identifier obscures unaided human interpretation of the first outcome and the second outcome. Human interpretation may include a user's ability to read the identifier and deduce a remediation level of the remediation content associated with the identifier. In some instances, human interpretation may be aided by the use of a computer, server, or user device used to translate the identifier. For example, a computer can easily calculate a complex mathematics problem, whereas the human interpretation of the same mathematics problem would take more time or be unsolvable for the human. The human can use a computer to help solve the mathematics problem. In another example, a computer can easily see a pattern in a coded identifier (e.g., “OLLEH” is “HELLO” backwards), whereas the human interpretation of the pattern may take more time or be unsolvable. In some embodiments, unaided human interpretation will not include these computers, servers, or user devices.

In some embodiments, the identifier uniquely identifies a plurality of instructional content for remediating performance on the diagnostic test. For example, the identifier includes “2B” which indicates the user performed poorly on the sentence structure portion of the reading comprehension section of the diagnostic test. Based in part on the “poor” performance identified by the identifier, the instructional content for remediating performance on the diagnostic test can include lectures, instructional videos, tutorials, question/answer portions, step-by-step instructions, supplemental learning material, references to books or instructions in content, or other information to help remediate performance on the diagnostic test. In some examples, the user will review and/or practice performing problems from a particular section using the instructional content. The user can improve performance on future diagnostic tests or learn the instructional content provided for the one or more sections.

The identifier engine 220 can also be configured to transmit the identifier. In some embodiments, the identifier is transmitted to a user device to enable the user device to access instructional content associated with the diagnostic test. The identifier engine 220 can interact with the network interface 200 to transmit the identifier to the user device 140.

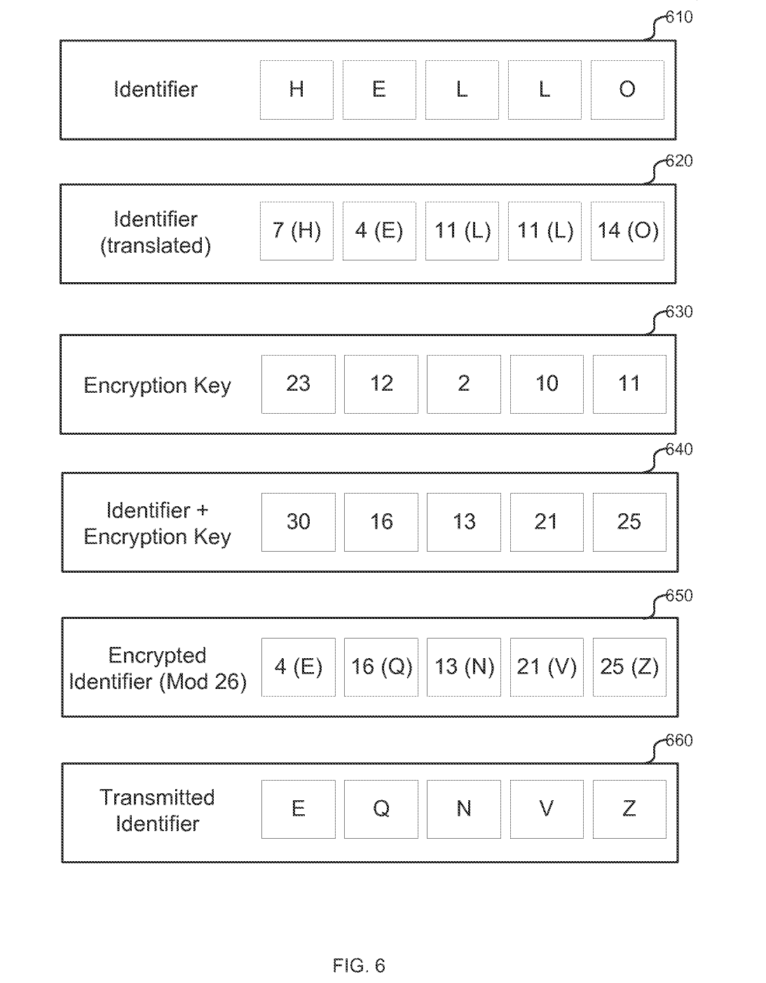

The identifier engine 220 can also be configured to encrypt and/or decrypt the identifier. The identifier may be encrypted before the identifier is transmitted. For example, the identifier engine 220 may generate an identifier and alter the identifier to form an encrypted identifier. Details and features of one type of encryption process are provided in association with FIG. 6.

The testing server 110 also includes a user engine 230. The user engine 230 can be configured to identify a user and/or a user device. For example, the user engine 230 identifies the user associated with the user device as John Smith in a Colorado high school in Grade 12. The user engine 230 may also identify the type of user device operated by the user (e.g., mobile device, tablet, desktop computer) and/or alter instructional content based in part on the identification of the user and/or user device. For example, when the user is identified as an English-speaker, the instructional content is provided in English. In another example, when the user is identified as operating a mobile device, the instructional content is provided for a smaller screen than when the user device is identified as a desktop computer.

The user engine 230 can also be configured to interact with the user data store 290. For example, the user engine 230 identifies the name, user name, student identifier, user device identifier, user device type, payment method, or other information associated with a user. The user engine 230 can interact with the user data store 290 to store the information. The user engine 230 may also retrieve the data for future uses and/or to process analytics.

The testing server 110 also includes an analytics engine 240. The analytics engine can be configured to display the results of a diagnostic test. For example, the results of the diagnostic test provide the user with a summary of the test answers, correct answers, information about the diagnostic test (e.g., date, title of the test, time allotted to take the test, test provider), or any subsequent steps that the user can consider to improve performance (e.g., by reviewing the instructional content).

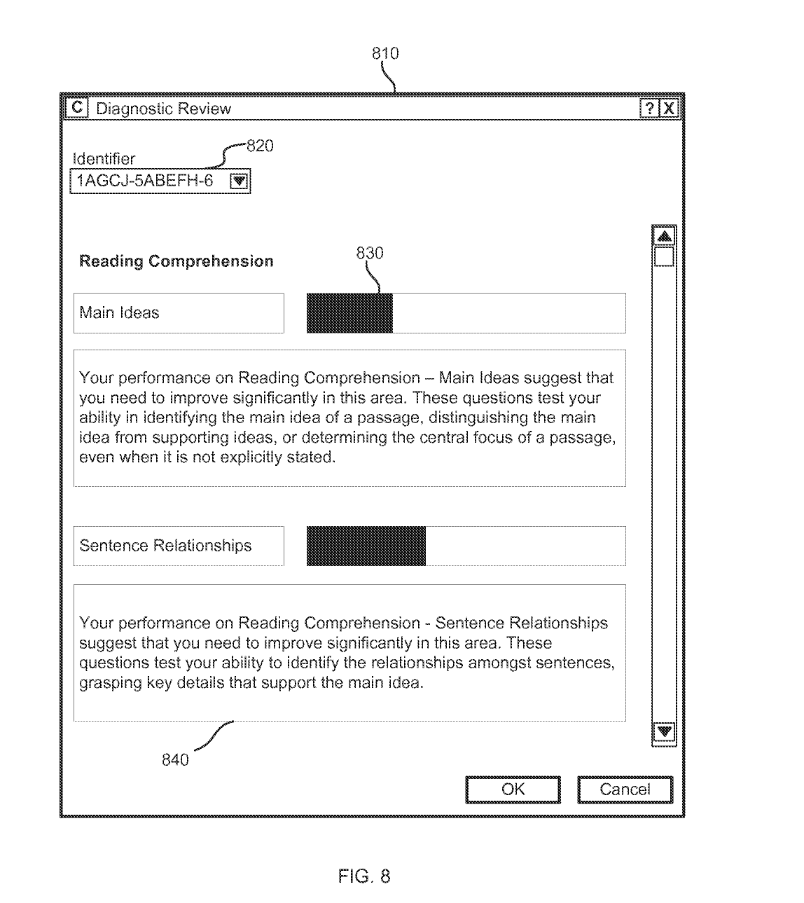

The analytics engine 240 can also be configured to generate feedback that identifies the performance of the user. The feedback can include various types of information. For example, the feedback includes at least one psychographic illustration depicting the performance of the user. In another example, the feedback includes at least one human-readable description associated with the performance of the user. The analytics engine 240 can also be configured to transmit and/or display the feedback. For example, the feedback is displayed via a network page, presented using audio/visual information, or other formats for providing feedback. Details and features of feedback is provided in association with FIG. 8.

The testing server 110 also interacts with one or more data stores, including a diagnostic data store 270, identifier data store 280, and user data store 290. The data stores are associated with a distributed or local data system accessible by the testing server 110.

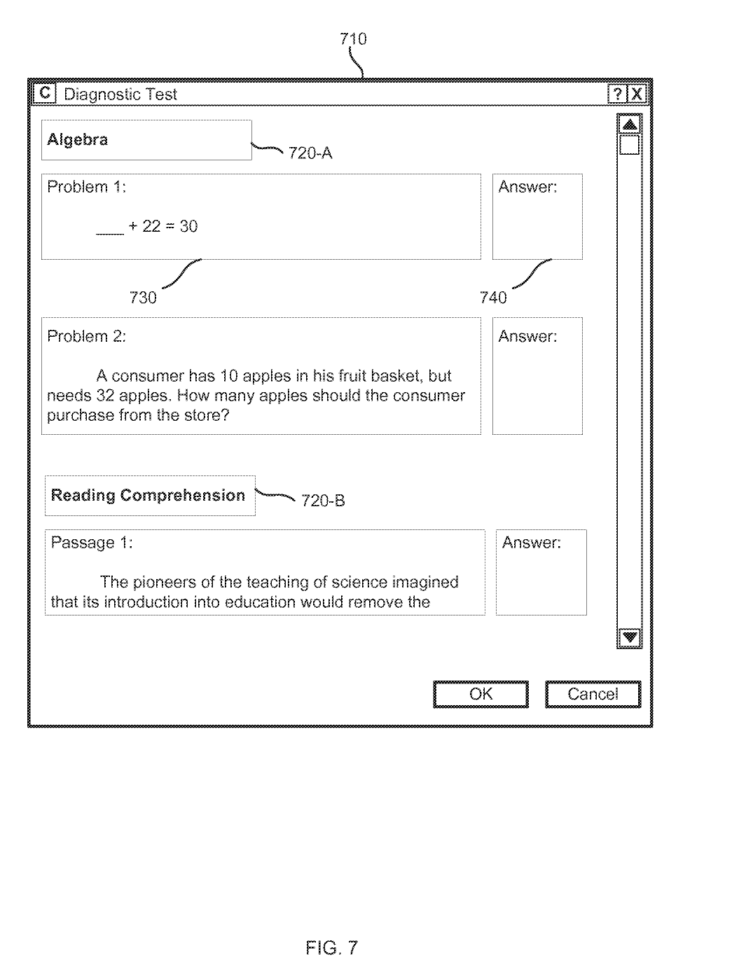

The diagnostic data store 270 may be configured to store information related to diagnostic tests, including diagnostic test questions. For example, a diagnostic test question that includes an algebraic test section in a diagnostic test can include: “______+22=30.” In another example, a diagnostic test question that includes an algebraic test section in a diagnostic test can include: “A consumer has 10 apples in his fruit basket, but needs 32 apples. How many apples should the consumer purchase from the store?” Details and features of a sample diagnostic test is provided in association with FIG. 7.

The diagnostic data store 270 may also be configured to store points or weighted values that correlate with the diagnostic test questions or the section of the diagnostic test. For example, when the first question incorporates several algebraic concepts in one question and the second question incorporates only one elementary concept in one question, the first question may be harder than the second question. The diagnostic data store 270 can associate 2 points for the first question and 1 point for the second question.

In one embodiment, for example, the diagnostic data store 270 receives a plurality of test sections from an administrator or test publisher that include one or more diagnostic test questions in each section. The questions, sections, origin of the information, upload date, or other information may be stored in the diagnostic data store 270 to help create and/or analyze the diagnostic test.

The identifier data store 280 is configured to store information related to the identifier. For example, the identifier data store 280 stores the identifier (e.g., for future use, as a back-up to providing the identifier to the user device). In some examples, the identifier data store 280 also identifies a user and/or user device associated with an identifier.

The identifier data store 280 may also be configured to store instructional content associated with remediating performance identified by the identifier. For example, when the identifier includes an identifier portion “2B,” which indicates the user performed poorly on a section of the diagnostic test, the instructional content may be stored in the identifier data store 280 to correlate with that identifier and/or identifier portion. In another example, the identifier data store may include references to the instructional content stored in another location (e.g., text file, webpage, instructional content data store).

The user data store 290 stores information related to a user or user device. For example, the user data store 290 stores a credential, authentication identifier, device identifier, user identifier, identifier associated with the user of a diagnostic test, user name, payment information, or other information that allows the user of the device to access, manage, receive, generate, or otherwise interact with the diagnostic test and/or instructional content. The user data store 290 may also store a user's test answers, access code, or other information provided by the user to access the diagnostic test and/or instructional content.

With reference now to FIG. 3, a block diagram of one embodiment of a remediation server with one or more data stores for implementing deidentified access of instructional content is shown. For example, the remediation server 120 includes a network interface 200-B, instructional content engine 310, identifier engine 320, check engine 330, access engine 340, and one or more data stores, including an instructional content data store 370 and access data store 380.

As depicted in FIG. 3, the remediation server 120 includes a network interface 200 (herein shown as 200-B). The network interface 200 allows the devices, networks, and other systems to access the other components of the system 100. The network interface 200 includes features configured to send and receive information, including, for example, an antenna, a modem, a transmitter, receiver, or any other feature that can send and receive information. The network interface 200 can communicate via telephone, cable, fiber-optic, and other wired communication network. In some embodiments, the network interface 200 communicates via cellular networks, WLAN (wireless local area networking) networks, or any other wireless network.

The network interface 200 can also be configured to send and receive data. In some embodiments, the network interface 200 receives an identifier associated with a user of a diagnostic test, receives a plurality of instructional content, transmits one or more sections of instructional content, or receives a key (e.g., to identify remediation levels in an identifier, to identify a secret for decrypting an encrypted identifier). For example, the network interface 200 transmits the instructional content to a user device 140 that corresponds to the sections of the diagnostic test.

The remediation server 120 also includes an instructional content engine 310. The instructional content engine 310 can be configured to determine a plurality of instructional content corresponding with a diagnostic test. As shown, the diagnostic test can diagnose the performance of a user. The diagnostic test can include a first section of the diagnostic test and a second section of the diagnostic test, and the plurality of instructional content can include a first section of instructional content and a second section of instructional content. The plurality of instructional content can include one or more questions directed to improving the performance of the user (e.g., on a diagnostic test).

The instructional content engine 310 can also be configured to determine instructional content in association with the level of remediation. For example, a first section of instructional content is determined in association with a first level of remediation, so that the first section of instructional content helps to remediate performance on the first section of the diagnostic test. In another example, a second section of instructional content is determined in association with the second level of remediation, so that the second section of instructional content is identified for remediating performance on the second section of the diagnostic test.

The instructional content engine 310 can also be configured to display the plurality of instructional content. In some embodiments, the instructional content may be transmitted to a user device to enable the user remediate performance on a diagnostic test. The instructional content engine 310 interacts with the network interface 200 to transmit the instructional content to a user device 140.

The instructional content engine 310 can also be configured to interact with the instructional content data store 370. For example, when the instructional content engine 310 identifies one or more sections of instructional content, the instructional content engine 310 interacts with the instructional content data store 370 to store the information. The instructional content engine 310 may retrieve the data for future uses and/or to process analytics.

The remediation server 120 also includes an identifier engine 320. The identifier engine 320 can be configured to receive an identifier associated with the user of the diagnostic test. As shown, the identifier may be associated with a user of a diagnostic test. The identifier can also uniquely indicate one or more outcomes of the diagnostic test. The coding of the identifier can also obscure unaided human interpretation of the one or more outcomes. The identifier may also uniquely identify the plurality of instructional content for remediating performance on the diagnostic test.

For example, the identifier engine 320 is configured to identify “A” as a low score in the fractions section of diagnostic arithmetic and “G” as a medium score in the division section of diagnostic arithmetic. In another example, the identifier engine 320 is configured to identify “TA” as a low score in the fractions section of diagnostic arithmetic and “GR” as a medium score in the division section of diagnostic arithmetic. The identifier engine 320 can be configured to identify a single character, digit, or symbol as an identifier portion, or identify one or more characters, digits, or symbols as an identifier portion.

The identifier engine 320 can also be configured to identify identifier portions by a particular length. For example, the identifier engine 320 can identify each identifier portion as 1 or 2 characters, digits, or symbols in length. In another example, each identifier portion is 1 digit or 1 character. In yet another example, the identifier engine 320 can be configured to identify variable-length identifier portions (e.g., a first identifier is “A” because it matches a list of known identifier portions, the second identifier is “BB” because “B” is not a known identifier portion and “BB” is a known identifier portion).

The identifier engine 320 can also be configured to identify a plurality of remediation levels in association with the identifier. For example, the plurality of remediation levels identify the remediation needed for the user based in part on the performance on the diagnostic test. The remediation levels can include a first level of remediation and a second level of remediation, such that the first level of remediation corresponds with the first section of the diagnostic test, and the second level of remediation corresponds with the second section of the diagnostic test.

The identifier engine 320 can also be configured to encrypt and/or decrypt the identifier. For example, the identifier is decrypted before the remediation levels are identified in association with the identifier. In another example, the identifier is decrypted once the identifier is received from the user device. Details and features of the encryption process is provided in association with FIG. 6.

The identifier engine 320 can also be configured to interact with the identifier data store 280. For example, the identifier engine 320 can receive the identifier from the user device and/or the identifier data store 280. The identifier engine 320 may store and/or retrieve the identifier from the identifier data store 280.

The remediation server 120 also includes a check engine 330. The check engine 330 can be configured to identify a check portion with the identifier. The check portion can confirm that the identifier is provided correctly. For example, when the user provides the identifier with the appropriate check portion to the server, the server can quickly identify that the identifier was provided correctly (e.g., typed, spoken, copied, pasted) by the user. In another example, the network page can include a scripting language to check the identifier locally at the user device without transmitting the identifier to the remediation server 120.

In an illustrative example, the identifier is “1AGCJ-5ABEFH.” The server can calculate the check portion by first assigning numeric values to any characters in the identifier (e.g., “A” is “1,” “B” is “2,” . . . “Z” is 26″). Using this initial character translation, the identifier becomes “117310512568.” The server can then implement one or more arithmetic operations to form the check portion. For example, the server can add all digits to form a single-digit check portion number (e.g., 1+1+7+3+ . . . +8=40; 4+0=4). The check portion number would be 4. In another example, the server can add the digits placed in every other position or in each odd position (e.g., 1+7+1+5+2+6=22), multiply the sum by 3 (e.g., 22×3=66), and combine the results of each arithmetic operation to form a final check portion number (e.g., 22+66=88; 8+8=16; 1+6=7). The check portion number would be 7.

In yet another example, a more complex, multi-step process may be performed to form the check portion. First, add the digits placed in odd positions (e.g., 1+7+1+5+2+6=22). Second, multiply the sum by 3 (e.g., 22×3=66). Third, add the digits placed in even positions (e.g., 1+3+0+1+5+8=18). Fourth, add the results from the second and third steps, including multiplying the odd digits by 3 and adding the even digits (e.g., 66+18=84). Fifth, divide the result by 10 and keep the remainder (e.g., remainder of 84/10=4). Sixth, subtract by 10 (e.g., 10−4=6). The check portion number would be 6.

The remediation server 120 also includes an access engine 340. The access engine 340 can be configured to receive an access code associated with the user of the diagnostic test. The access code can indicate that a user and/or user device is allowed access to the plurality of instructional content (e.g., via a payment). The access engine 340 can authenticate the access code before displaying the plurality of instructional content and/or confirm that the particular user and/or user device has access to the instructional content (e.g., after the access code is transmitted to the user device).

The access engine 340 can also be configured to receive a payment. For example, the access engine 340 receives an account number, check, fee transfer, or interacts with a third party who confirms the payment. A payment confirmation can be generated and stored with the user data store 290 and/or the access data store 380. At payment confirmation, the user may be provided with access to the instructional content through the use of an access code.

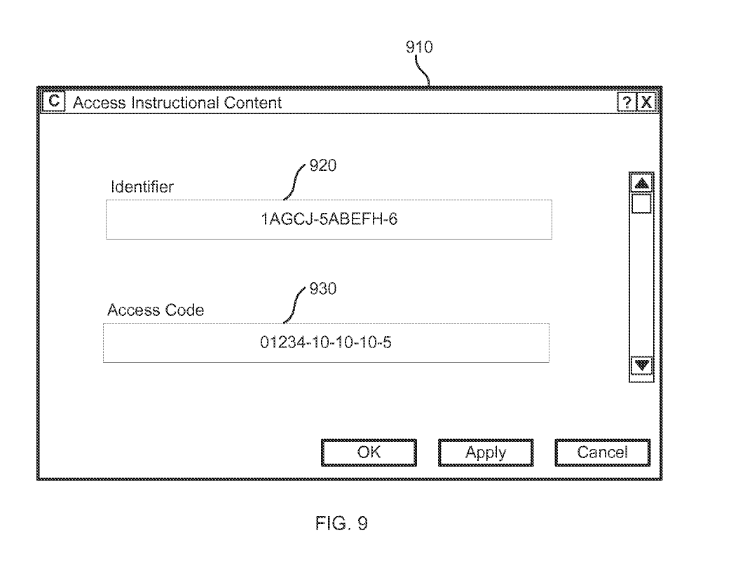

The access engine 340 can also be configured to generate the access code. The access code can include one or more alphanumeric characters, including alphabetic characters, digits, and/or symbols that are associated with the payment confirmation. For example, an access code can be “01234-10-10-10-5.” In some embodiments, the access engine 340 interacts with the access data store 380 to store the access code in the access data store 380 in association with a user. Details and features of a graphical user interface that receives an access code is provided in association with FIG. 9.

The access engine 340 can also be configured to manage access based in part on the origin of the payment. For example, when the payment is provided by a government agency on behalf of the user, the user can receive additional instructional content and/or receive instructional content for a predetermined amount of time based in part on the limitations set by the government agency. In another example, when the payment is provided by the user, the user can receive instructional content as long as the user continues to pay a reoccurring fee (e.g., monthly access, access for a semester).

The access engine 340 can also be configured to interact with the access data store 380. For example, when the access engine 340 receives an access code, the access engine 340 interacts with the access data store 380 to store the access code (e.g., in association with a user and/or user device). In another example, the access code may be checked against other access codes that are already stored in the access data store 380 to confirm that the access codes has only been used once. The access engine 340 may retrieve the data for future uses and/or to process analytics.

The remediation server 120 also interacts with one or more data stores, including an instructional content data store 370 and access data store 380. The data stores are associated with a distributed or local data system accessible by the remediation server 120.

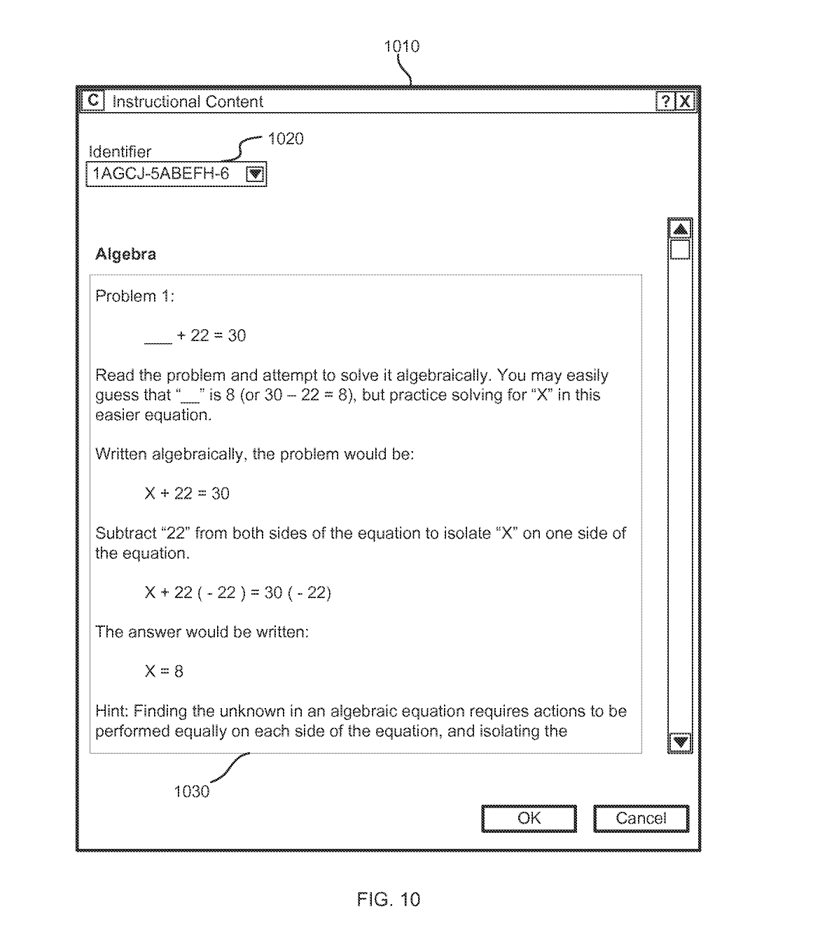

The instructional content data store 370 stores information related to instructional content. In some embodiments, for example, the instructional content data store 370 includes instructional content or references to instructional content for remediating performance on the diagnostic test, including lectures, instructional videos, tutorials, question/answer portions, step-by-step instructions, supplemental learning material, references to books or instructions in content, or other information to help remediate performance on the diagnostic test. Details and features of instructional content is provided in association with FIG. 10.

The access data store 380 stores information related to one or more access codes. For example, an access code can be “01234-10-10-10-5.” The access code can be stored in the access data store 380, along with information associated with the access code, including a corresponding user, account number, check, fee transfer, third party user, or payment confirmation. One or more access codes may be associated with a user.

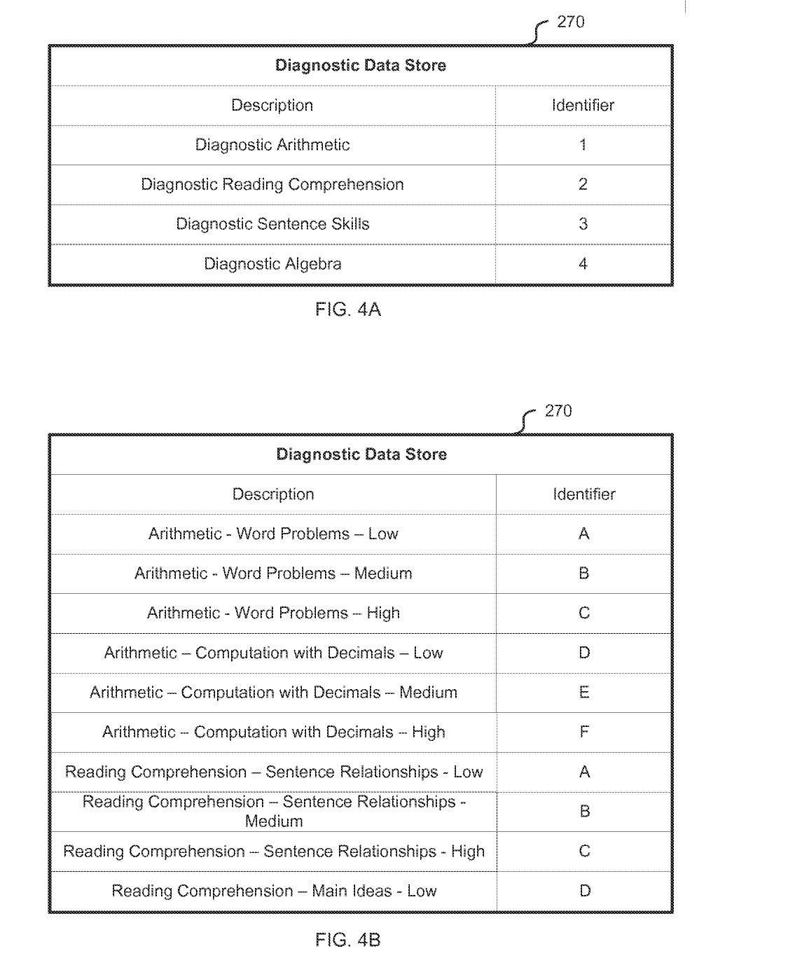

With reference now to FIGS. 4A-4B, illustrations of data that are stored in the diagnostic data store are shown. As shown in FIG. 4A, the illustration shows a plurality of test sections in a diagnostic test that are associated with an identifier or an identifier portion. For example, a diagnostic test includes a plurality of test sections including diagnostic arithmetic, diagnostic reading comprehension, diagnostic sentence skills, and diagnostic algebra. One or more sections of the diagnostic test may be associated with an identifier and/or identifier portion. For example, the diagnostic arithmetic section of the diagnostic test is associated with a “1” identifier portion, the diagnostic reading comprehension section of the diagnostic test is associated with a “2” identifier portion, the diagnostic sentence skills section is associated with a “3” identifier portion, and the diagnostic algebra section is associated with a “4” identifier portion.

In some embodiments, the identifier portions are concatenated to generate an identifier. For example, when the diagnostic test includes diagnostic arithmetic and diagnostic reading comprehension, “1” and “2” may be concatenated to create an identifier of “12.” The identifier may correlate to a plurality of instructional content to remediate performance in arithmetic and reading comprehension.

As shown in FIG. 4B, the illustration shows a plurality of test sections in a diagnostic test that are associated with an identifier or identifier portion. For example, the diagnostic test includes a plurality of test sections including diagnostic arithmetic, diagnostic reading comprehension, diagnostic sentence skills, and diagnostic algebra.

One or more test sections in the diagnostic test are also associated with a plurality of remediation levels, including “low,” “medium,” and “high.” For example, when the user performs poorly on an arithmetic word problem section, the section associated with that user's performance is “arithmetic—word problems—low.” In another example, when the user performs average on an arithmetic word problem section, the section associated with that user's performance is “arithmetic—word problems—medium.” In another example, when the user performs well on an arithmetic word problem section, the section associated with that user's performance is “arithmetic—word problems—high.” Each of these sections may correspond with an absolute number of correct answers (e.g., 1-3 correct is “low,” 4-6 correct is “medium,” 7-10 correct is “high”) or weighted average of correct answers, based in part on the difficulty of the particular test question and/or section of the diagnostic test.

In some embodiments, the one or more sections of the diagnostic test and the remediation level are associated with identifiers and/or identifier portions. For example, when the user performs poorly on an arithmetic word problem section, this section of the diagnostic test is associated with an “A” identifier portion. When the user performs average on the arithmetic word problem section, this section of the diagnostic test is associated with a “B” identifier portion. When the user performs well on the arithmetic word problem section, this section of the diagnostic test is associated with a “C” identifier portion. When the user performs poorly on the arithmetic computation with decimals section, this section of the diagnostic test is associated with a “D” identifier portion, and so on as illustrated.

In some embodiments, the identifier portions are concatenated to generate an identifier. For example, when the diagnostic test includes diagnostic arithmetic, the user performed poorly on the arithmetic word problem section (e.g., “A”) and also performed poorly on the arithmetic computation with decimals section (e.g., “D”), “A” and “D” may be concatenated to create an identifier of “AD.” Other identifier portions are added as well, including an identifier portion associated with the generic test section, diagnostic arithmetic (e.g., “1”), to create an identifier of “1AD.” The identifier may correlate to a plurality of instructional content to remediate performance (e.g., in arithmetic).

In some embodiments, the identifier portions from a plurality of test sections are concatenated to generate an identifier. For example, when the diagnostic test includes diagnostic arithmetic (e.g., “1”) and diagnostic reading comprehension (e.g., “2”), and the user performed poorly on the arithmetic word problem section (e.g., “A”), but performed well on reading comprehension sentence relationships (e.g., “C”), each of the identifier portions may be concatenated to create an identifier of “1A2C,” “2C-1A,” or “1A-2C.” The identifier may correlate to a plurality of instructional content to remediate performance (e.g., in arithmetic and reading comprehension).

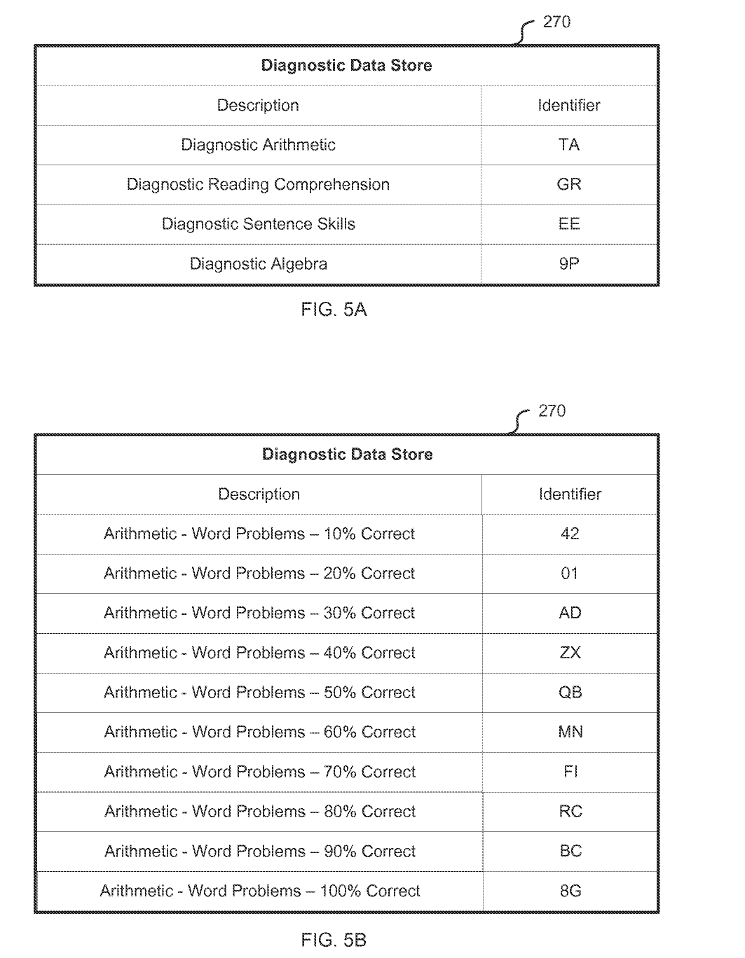

With reference now to FIGS. 5A-5B, illustrations of data that are stored in the diagnostic data store are shown. As shown in FIG. 5A, the illustration shows a plurality of test sections in a diagnostic test that are associated with an identifier or an identifier portion. For example, a diagnostic test includes a plurality of test sections including diagnostic arithmetic, diagnostic reading comprehension, diagnostic sentence skills, and diagnostic algebra. One or more sections of the diagnostic test may be associated with an identifier and/or identifier portions, including diagnostic arithmetic with “TA,” diagnostic reading comprehension with “GR,” diagnostic sentence skills with “EE,” and diagnostic algebra with “9P.”

In some embodiments, the identifier portions are concatenated to generate an identifier. For example, when the diagnostic test includes diagnostic arithmetic and diagnostic reading comprehension, “TA” and “GR” may be concatenated to create an identifier of “TAGR” or “TA-GR.” The identifier may correlate to a plurality of instructional content to remediate performance in arithmetic and reading comprehension.

As shown in FIG. 5B, the illustration shows a plurality of test sections in a diagnostic test that are associated with an identifier or identifier portion. For example, the diagnostic test includes a plurality of test sections including diagnostic arithmetic, diagnostic reading comprehension, diagnostic sentence skills, and diagnostic algebra.

One or more test sections in the diagnostic test are also associated with a plurality of remediation levels, including “10% correct,” “20% correct,” through “100% correct.” For example, when the user answers only 10-percent of the questions correctly on an arithmetic word problem section, the section associated with that user's performance is “arithmetic—word problems—10% correct.” In another example, when the user answers only 50-percent of the questions correctly on an arithmetic word problem section, the section associated with that user's performance is “arithmetic—word problems—50% correct.” In another example, when the user answers 90-percent of the questions correctly on an arithmetic word problem section, the section associated with that user's performance is “arithmetic—word problems—90% correct.”

In some embodiments, the one or more sections of the diagnostic test and the remediation level are associated with identifiers and/or identifier portions. For example, when the user answers only 10-percent of the questions correctly on an arithmetic word problem section, this section of the diagnostic test is associated with an “42” identifier portion. When the user answers only 50-percent of the questions correctly on the arithmetic word problem section, this section of the diagnostic test is associated with a “QB” identifier portion. When the user answers 90-percent of the questions correctly on the arithmetic word problem section, this section of the diagnostic test is associated with a “BC” identifier portion, and so on as illustrated.

In some embodiments, the identifier portions are concatenated to generate an identifier. For example, when the diagnostic test includes diagnostic arithmetic (e.g., “TA”) and the user answers only 10-percent of the questions correctly on the arithmetic word problem section (e.g., “42”), “TA” and “42” may be concatenated to create an identifier of “TA42.” The identifier may correlate to a plurality of instructional content to remediate performance in one or more sections of the diagnostic test.

With reference now to FIG. 6, an illustration of an example encryption process of an identifier is shown. In some embodiments, the identifier is encrypted (e.g., by the server) before the identifier is transmitted and decrypted after the identifier is received (e.g., by the server). Encryption may encode the identifier so that third parties cannot read the identifier, even if the third party possesses the answer key that identifies the identifier portions for a particular remediation level within the identifier (e.g., “QB” means that the user answers 50-percent of the questions correctly on the arithmetic word problem section). For example, the encryption process includes any encryption algorithm to encrypt the identifier, including a one-time pad encryption (as shown), symmetric key encryption, or public key encryption.

At block 610, the identifier is generated as “HELLO.” The identifier can be associated with the user of the diagnostic test and uniquely indicate the outcome of one or more sections of the diagnostic test (e.g., based in part on a comparison of the user's test answers with the correct answers). For example, the “H” represents diagnostic arithmetic, “E” represents performing well on arithmetic word problems, “LL” represents performing poorly on arithmetic computation with decimals, and “O” represents performing well on arithmetic with percentage calculations. As shown in some examples, the module that parses the identifier is configured to identify (e.g., parse) one character, digit, or symbol at a time (e.g., H, E, O), more than one character, digit, or symbol at a time (e.g., LL), or a combination of one or more than one character, digit, or symbol at a time.

At block 620, the identifier is translated to a numerical equivalent. For example, one method of translating the identifier to a numerical equivalent corresponds with associating each character to the position that the number occupies in a 0-25 letter alphabet (e.g., “A” is 0, “B” is 1, “C” is 2). In this example, the identifier is translated to “7-4-11-11-14,” which corresponds with “H” as the 7^{th} letter, “E” as the 4^{th} letter, “L” as the 11^{th} letter, and “O” as the 14^{th} letter.

At block 630, the encryption key is identified. For example, when using a one-time pad encryption, the encryption key identifies a corresponding value from a secret random key (e.g., the 10^{th} sheet on a pad on June 1^{st}, the next available key in a pad of potential encryption keys). The encryption key can identify that the first digit should be combined with the number “23,” the second digit should be combined with “12,” the third digit should be combined with “2,” the fourth digit should be combined with “10,” and the fifth digit should be combined with “11.” The encryption key may be unique for each encryption (e.g., only used once) and kept secret. In this example, the key is combined with each character, digit, or symbol of the identifier, so “7” or “H” should be combined with “23,” “4” or “E” should be combined with “12,” “11” or “L” should be combined with “2,” “11” or “L” should be combined with “10,” and “14” or “0” should be combined with “11.”

In some embodiments, the testing server 110 and the remediation server 120 each possess the encryption key for encrypting and decrypting the identifier. For example, the testing server 110 and the remediation server 120 each identify the appropriate unused page from the pad. The corresponding page at each location can identify the same key (e.g., the first digit should be combined with the number “23,” the second digit should be combined with “12”), so that when the testing server 110 combines the key with the identifier to encrypt the identifier, the remediation server 120 can combine the key with the identifier to decrypt the identifier.

At block 640, the encryption key and identifier are combined. For example, “7” is combined with “23” to form “30,” “4” is combined with “12” to form “16,” “11” is combined with “2” to form “13,” “11” is combined with “10” to form “21,” and “14” is combined with “11” to form “25.” The combination creates a combined identifier of “30-16-13-21-25.”

At block 650, the modular remainder is identified from the combined key and identifier, so that when the combined key and identifier is a value larger than 26, the remainder after subtraction of 26 is taken as the new digit. For example, since “30” is greater than “26,” the modular value for the first digit is calculated and replaced with “4.” Since each of the other digits is less than “26,” the other digits remain unchanged after the combination, creating an encrypted identifier “4-16-13-21-25,” which corresponds with “E” as the 4^{th} letter, “Q” as the 16^{th} letter, “N” as the 13^{th} letter, “V” as the 21^{st} letter, and “Z” as the 25^{th} letter.

At block 660, the digits are translated back to letter values and transmitted. In some examples, the letter values may be the same length of characters, digits, or symbols in the original identifier. For example, the encrypted identifier is “EQNVZ,” which corresponds with the decrypted identifier “HELLO.”

With reference now to FIG. 7, an illustration of a graphical user interface for displaying a diagnostic test is shown. The diagnostic test is provided on a graphical user interface (GUI) 710. As shown, the GUI 710 can include one or more sections of a diagnostic test 720 (herein shown as 720-A and 720-B), one or more test questions 730, and one or more GUI input elements 740 to accept test answers, including text boxes. In some examples, the diagnostic test includes only one section of a diagnostic test 720 (e.g., only algebra or only reading comprehension).

The GUI 710 includes one or more sections of a diagnostic test 720. As shown, the sections of the diagnostic test are “algebra” and “reading comprehension.” The sections may include subjects (e.g., arithmetic, sentence skills), difficulty levels (e.g., low difficulty, high difficulty), test types (e.g., logic, reading, games), nested sets of questions (e.g., one prompt for seven questions), timeframes (e.g., day 1 questions, day 2 questions), or other portions of a diagnostic test.

The GUI 710 also includes one or more diagnostic test questions 730. The test questions can vary by the type of diagnostic test and/or sections presented in the diagnostic test. As shown, the diagnostic test question that includes an algebraic test section in a diagnostic test can include: “______+22=30.” In another example, a diagnostic test question that includes an algebraic test section in a diagnostic test can include: “A consumer has 10 apples in his fruit basket, but needs 32 apples. How many apples should the consumer purchase from the store?”

The GUI 710 also includes one or more GUI input elements 740. As shown, the GUI input elements 740 can include test boxes. Alternative GUI input elements can include radio buttons, drop-down menus, or expanded text boxes (e.g., to enter essay-type responses). The user may use the GUI input elements 740 to provide responses (e.g., type, select) in order to generate a test answer to a particular test question. For example, in response to question 1, the user can type “8” and in response to question 2, the user can type “22.”

With reference now to FIG. 8, an illustration of a graphical user interface for displaying a diagnostic review is shown. The diagnostic review is provided on a graphical user interface (GUI) 810. As shown, the GUI 810 includes an identifier 820 and feedback, including a psychographic illustration 830 and a human-readable description 840 associated with the performance of the user.

The GUI 810 includes an identifier 820. In some embodiments, the identifier is received from a user device after the user completes the diagnostic test. For example, as shown, the user's test answers are received for a plurality of test sections in a diagnostic test. The test answers are compared with the correct answers in a key and an outcome is determined for each section for the diagnostic test, based in part on the comparison. The identifier can uniquely indicate the outcome of one or more sections of the diagnostic test.

The GUI 810 also includes feedback. The feedback can identify the performance of the user on the diagnostic test. For example, when the identifier indicates that the user's performance on the main ideas portion of the reading comprehension section was low, the feedback can identify the poor performance appropriately.

The feedback can include a psychographic illustration 830, including bars, lines, charts, graphics, or other formats for presenting information to a user. For example, feedback for a section may display a colored-bar chart, where a color (e.g., green) identifies a relatively “high” outcome and a different color (e.g., red) identifies a relatively “low” outcome. In another example, the placement of the bar is affected by the difficulty level of the test questions. For instances, the illustrated feedback can be identical for a student that answered 6 easy questions correctly out of 10 total questions, and the student that answered 3 difficult questions correctly out of 10 total questions. The psychographic illustration 830 can highlight which test sections need improvement or meet a minimum standard of competency based in part on the analysis.

The feedback can include a human-readable description 840 associated with the performance of the user. A human-readable description may include a representation of data or information that can be naturally read by humans. For example, the human-readable description 840 includes the test section (e.g., Reading Comprehension—Sentence Relationships), a description of the test section (e.g., “These questions test your ability to identify the relationships amongst sentences, grasping key details that support the main idea.”), the outcome and/or suggestions to improve performance (e.g., “you need to improve significantly in this area”), or other information.

With reference now to FIG. 9, an illustration of a graphical user interface for accessing instructional content is shown. A graphical user interface (GUI) 910 for accessing instructional content is provided. As shown, the GUI 910 includes an identifier 920 and an access code 930.

The GUI 910 includes an identifier 920. For example, the identifier is received from a user device after the user completes the diagnostic test. After a user device receives an identifier, the user device provides the identifier to the GUI 910 to access the instructional content. The identifier can uniquely identify a plurality of instructional content for remediating performance on the diagnostic test.

The GUI 910 also includes an access code 930. For example, the user may provide the access code via a user device to the GUI 910. The access code can indicate that a user and/or user device is allowed access to the plurality of instructional content (e.g., via a payment). The GUI and/or server can authenticate the access code before displaying the plurality of instructional content and/or confirm that the particular user and/or user device has access to the instructional content.

With reference now to FIG. 10, an illustration of a graphical user interface for displaying instructional content is shown. A graphical user interface (GUI) 1010 for displaying instructional content is provided. As shown, the GUI 1010 includes an identifier 1020 and instructional content 1030.

The server may access a plurality of instructional content (e.g., stored in an instructional content data store 370) and/or determine which instructional content to utilize. The instructional content may include one or more sections of instructional content, including a first section of instructional content and a second section of instructional content. The sections of instructional content can correlate with the sections of the diagnostic test, including a first section of the diagnostic test and a second section of the diagnostic test.

The GUI 1010 receives the identifier and instructional content is identified for the particular identifier. For example, the identifier can help identify a plurality of remediation levels to help identify the remediation needed for the user based in part on the performance on the diagnostic test. The plurality of remediation levels can include a first level of remediation and a second level of remediation, so that the first level of remediation corresponds with the first section of the diagnostic test and the second level of remediation corresponds with the second section of the diagnostic test.

Once the instructional content is determined in association with the particular remediation needed for the identifier, the GUI 1010 displays the instructional content 1030. For example, instructional content 1030 includes an algebra problem and step-by-step instructions on how to approach solving the algebra problem. Other methods of providing instructional content may also be supported, including lectures, instructional videos, tutorials, question/answer portions, supplemental learning material, references to books or instructions in content, or other information to help remediate performance on the diagnostic test.

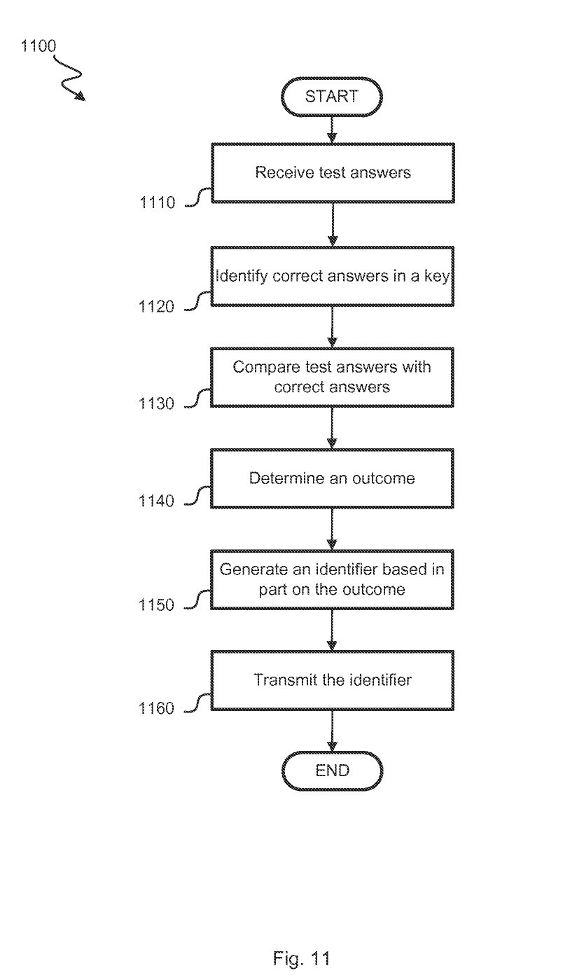

With reference now to FIG. 11, a flowchart illustrating one embodiment of implementing deidentified access of instructional content is shown. The process 1100 is performed by one or several of the components of the system 100. The process 1100 begins at block 1110 when test answers are received. For example, the user device provides a plurality of sections of a diagnostic test that include one or more test questions. The user operates the user device to provide test answers in response to the one or more test questions. The user device transmits the test answers to a server.

At block 1120, the process identifies correct answers in a key. For example, a server identifies the correct answers in a key (e.g., identifying the appropriate diagnostic test, identifying the appropriate version of the diagnostic test) and also receives the test answers. The server may also store the correct answers and/or answer key in a data store for future use.

At block 1130, the process compares the test answers with the correct answers. For example, the server can compare the appropriate correct answers with the corresponding test answers received from the user device. In some embodiments, the server can retrieve the correct answers from the data store and/or dynamically compare the correct answers to the received test answers from the user.

At block 1140, the process determines an outcome. For example, the outcome is based on the comparison. The comparison can identify one or more correct responses provided in one or more sections of the diagnostic test, including a first outcome for the comparison between the first set of test answers and the corresponding correct responses and a second outcome for the comparison between the second set of test answers and the corresponding correct responses.

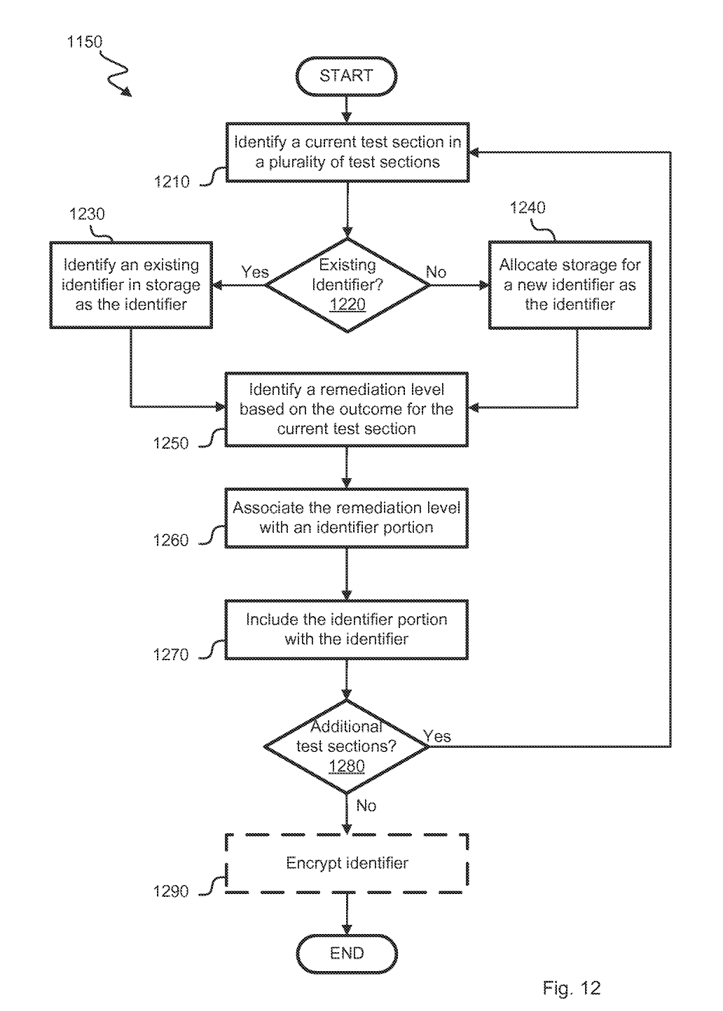

At block 1150, the process generates an identifier based in part on the outcome. The identifier may uniquely indicate the outcome of one or more sections of the diagnostic test. The identifier may also be coded to obscure unaided human interpretation of the outcome. The identifier may also uniquely identify a plurality of instructional content for remediating performance on the diagnostic test. Additional details and features of block 1150 are provided in association with FIG. 12.

With reference now to FIG. 12, a flowchart illustrating one embodiment of implementing deidentified access of instructional content is shown. The process 1150 is performed by one or several of the components of the system 100. The process 1150 begins at block 1210 by identifying a current test section in a plurality of test sections. For example, the current test section may be “algebra” out of a plurality of test sections including arithmetic, reading comprehension, sentence skills, and algebra.

At block 1220, the process determines whether an identifier exists. For example, the identifier may be associated with the user of a diagnostic test and the process can determine if the user is currently associated with one or more identifiers. This can include asking the user for the identifier, querying one or more data stores for an identifier, or other means of identifying an identifier for a user.

A decision from block 1220 may be made. If yes, the process proceeds to block 1230, where the process identifies an existing identifier in storage as the identifier. The identifier may be located in the identifier data store or other accessible temporary/permanent data store. If not, the process proceeds to block 1240, when the process allocates storage for a new identifier. For example, the process can dynamically allocate portions of storage (e.g. random access memory, virtual memory) and de-allocate the storage when the storage is no longer needed.

At block 1250, the process identifies the remediation level based on the outcome for the current test section. For example, the user may have performed poorly on algebra, identifying the need for remediation for most of the topics covered in the test section. In another example, the process can identify the remediation level for particular portions of the current test subject, including the “find a variable” section and the “evaluating algebraic expressions” section of the algebra test section.

At block 1260, the process associates the remediation level with an identifier portion. For example, the poor performance on algebra can be associated with an “A” identifier portion (e.g., meaning “low” or “poor performance”) or “1A” identifier portion (e.g., meaning “low” or “poor performance” on algebra). In another example, the poor performance for particular portions of the current test subject, including the “find a variable” section and the “evaluating algebraic expressions” section of the algebra test section can be associated with other identifier portions, including “1GCE” or “1A-2B.”

At block 1270, the process includes the identifier portion with the identifier. For example, the identifier portions are concatenated to generate an identifier. The “A” and “D” may be concatenated to create an identifier of “AD.” Other identifier portions are added as well, including an identifier portion associated with the generic test section, diagnostic algebra (e.g., “1”), to create an identifier of “1AD.” The identifier may correlate to a plurality of instructional content to remediate performance (e.g., in algebra).

At block 1280, the process determines whether additional sections of the diagnostic test are present. For example, when the user interacts with a diagnostic test that includes an algebra test section and a reading comprehension test section, and the process has not analyzed the reading comprehension test section, the process would determine that additional sections of the diagnostic test are present. As shown, some examples of a diagnostic test include only one section of a diagnostic test (e.g., only algebra or only reading comprehension), so the process can determine that no additional sections of the diagnostic test are present.

A decision from block 1280 may be made. If yes, the process returns to block 1210, where the process identifies a current test section in a plurality of test sections (e.g., reading comprehension, a subsequent test section after algebra). If not, the process proceeds to block 1290. At block 1290, the process encrypts the identifier. The encryption may be optional. For example, the encryption can encode the identifier so that third parties cannot read the identifier, even if the third party possesses the answer key that identifies the identifier portions for a particular remediation level.

Returning to FIG. 11 at block 1160, the process transmits the identifier. For example, the identifier is transmitted via a wired or wireless connection to one or more intranets, internets, public or private channels, communication tunnels between one or more servers, or other means of communication to a user device. The identifier may be encrypted before the identifier is transmitted. In another example, the identifier is transmitted to a data store to archive the identifier for future use.

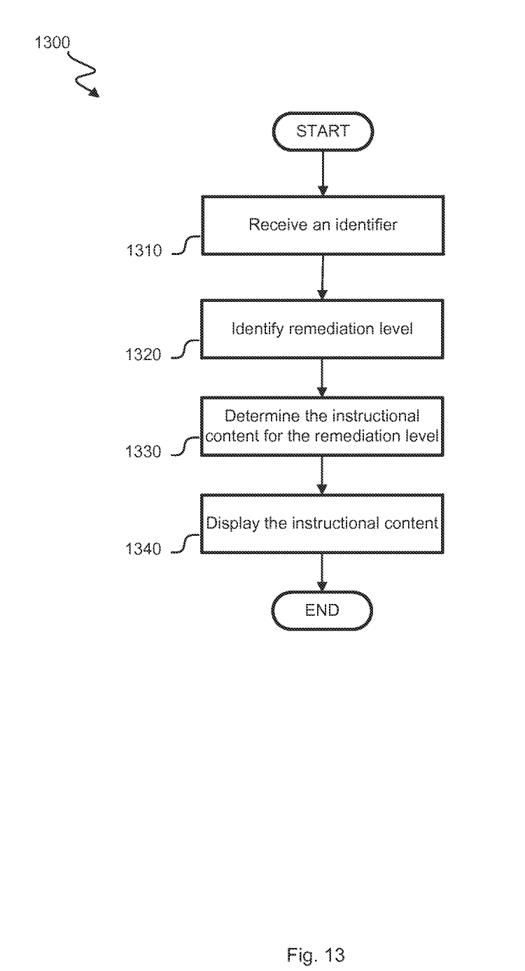

With reference now to FIG. 13, a flowchart illustrating one embodiment of implementing deidentified access of instructional content is shown. The process 1300 is performed by one or several of the components of the system 100. The process 1300 begins at block 1310 when the identifier is received. For example, the identifier is received via a wired or wireless connection to one or more intranets, internets, public or private channels, communication tunnels between one or more servers, or other means of communication from a user device. The received identifier may be encrypted. In another example, the identifier is received from a data store.

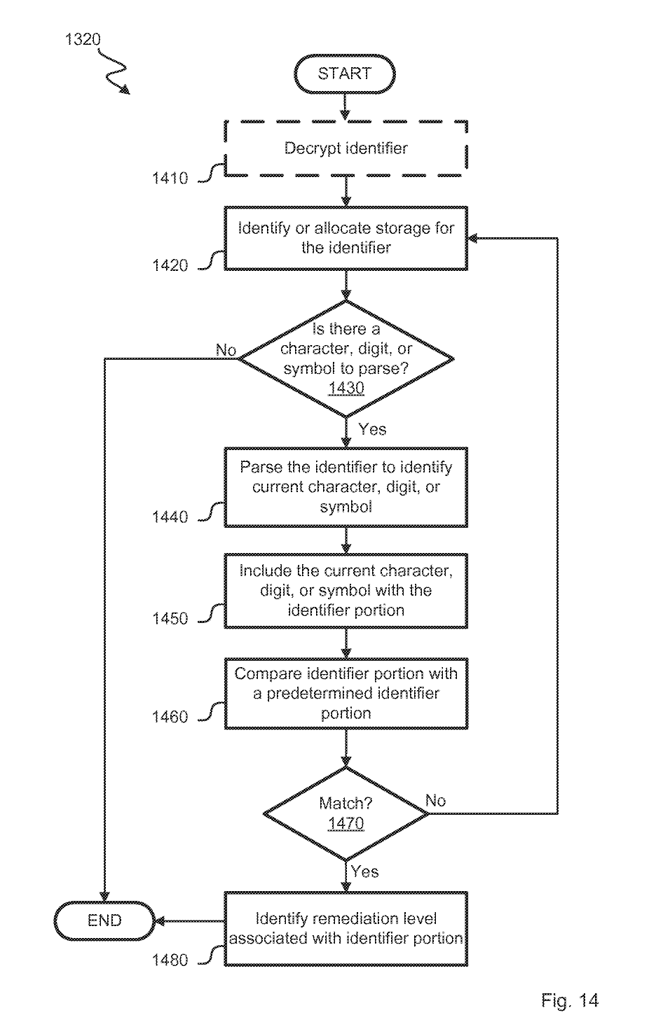

At block 1320, the process identifies a remediation level. For example, the plurality of remediation levels identify the remediation needed for the user based in part on the performance on the diagnostic test. Additional details and features of block 1320 are provided in association with FIG. 14.

With reference now to FIG. 14, a flowchart illustrating one embodiment of implementing deidentified access of instructional content is shown. The process 1320 is performed by one or several of the components of the system 100. The process 1320 begins at block 1410 by decrypting the identifier. The decryption may be optional. For example, the process may determine that the received identifier was encrypted and apply a key to decrypt the identifier (e.g., “XKRE” becomes “1ACG”), as shown in relation to FIG. 6.

At block 1420, the process identifies or allocates storage for the identifier. For example, the identifier may be stored with the identifier data store 280 or other accessible temporary/permanent data store. The process may dynamically allocate portions of storage (e.g. random access memory, virtual memory) and de-allocate the storage when the storage is no longer needed.

At block 1430, the process determines whether the identifier includes a character, digit, or symbol to parse. For example, the identifier “1ACG” includes four characters, digits, or symbols to parse, including “1,” “A,” “C,” and “G.” In another example, the identifier “2IRE-5ERW” includes nine characters, digits, or symbols to parse.

A decision from block 1430 may be made. In this example, the process would start at the first character, digit, or symbol to parse, and determine that a character, digit, or symbol is available to parse (e.g., “1”), resulting in proceeding to block 1440. At block 1440, the process parses the identifier to identify the current character, digit, or symbol. For example, at the first step, the process would identify “1.” In the second step, the process would identify “A,” and so on. Later, for example, if the process had already parsed “1,” “A,” “C,” and “G,” the process would determine that no additional characters, digits, or symbols are available to parse. In this instance, the process would end.

At block 1450, the process includes the current character, digit, or symbol with the identifier portion. For example, at the first step, the process would include “1” with the existing identifier. Since this is the first step, the existing identifier would be “ ”. The “1” identifier portion would be included with the existing identifier to generate “ ” and “1” or “1.” In the second step, the process would identify the existing identifier “1.” The process would include “A” with the existing identifier, to generate “1A” after the second step.

At block 1460, the process compares the identifier portion with a predetermined identifier portion. For example, the process would determine that “1” signifies an algebra test based in part on a predetermined identifier portion. The process could receive this information dynamically or in a previous process (not shown). Once the process identifies a current character, digit, or symbol at the first step (e.g., “1”), the process can compare the identifier with the predetermined identifier portion to determine if there is a match.

At block 1470, the process determines whether the identifier portion matches a predetermined identifier portion. In this example, a predetermined identifier portion “1” signifies an algebra test and the received identifier portion is “1.” Since these two sources match, the process may determine that the received identifier includes a test section associated with an algebra test.

A decision from block 1470 may be made. In this example, the identifier portion matches a predetermined identifier portion, so the process would proceed to block 1480. If no match (e.g., predetermined identifier portions included “1A,” “5,” and “T,” and the identifier portion included “1”), the process returns to block 1420.

At block 1480, the process identifies a remediation level associated with the identifier portion. For example, the “1” identifier can identify that instructional content is needed to remediate performance on the algebra section of the diagnostic test. In other examples, the identifier may identify particular portions of a section of the diagnostic test (e.g., sentence structure in reading comprehension, fractions in arithmetic) and correlate an appropriate remediation level for that section.

Returning to FIG. 13 at block 1330, the process determines the instructional content for the remediation level. For example, a “low” remediation level for algebra can correspond with step-by-step instructions on how to approach solving the algebra problem, 20 question/answer portions, and instructional videos providing at least 30 minutes of instruction on algebra. In another example, a “medium” remediation level for algebra can correspond with 10 question/answer portions and a 5-minute tutorial.

At block 1340, the process displays the instructional content. For example, the instructional content is provided through a graphical user interface (GUI) that includes the identifier and portions of the GUI reserved for displaying the instructional content. The displayed sections of instructional content can correlate with the sections of the diagnostic test that were identified by the identifier.

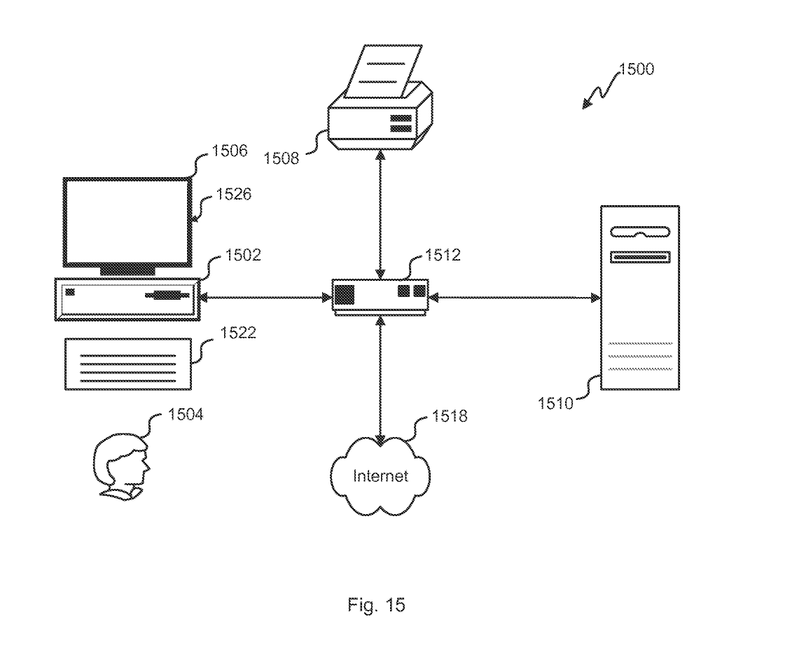

With reference now to FIG. 15, an exemplary environment with which embodiments may be implemented is shown with a computer system 1500 that can be used by a user 1504 as all or a component of the system 100. The computer system 1500 can include a computer 1502, keyboard 1522, a network router 1512, a printer 1508, and a monitor 1506. The monitor 1506, processor 1502 and keyboard 1522 are part of a computer system 1526, which can be a laptop computer, desktop computer, handheld computer, mainframe computer, etc. The monitor 1506 can be a CRT, flat screen, etc.

A user 1504 can input commands into the computer 1502 using various input devices, such as a mouse, keyboard 1522, track ball, touch screen, etc. If the computer system 1500 comprises a mainframe, a designer 1504 can access the computer 1502 using, for example, a terminal or terminal interface. Additionally, the computer system 1526 may be connected to a printer 1508 and a server 1510 using a network router 1512, which may connect to the Internet 1518 or a WAN.

The server 1510 may, for example, be used to store additional software programs and data. In one embodiment, software implementing the systems and methods described herein can be stored on a storage medium in the server 1510. Thus, the software can be run from the storage medium in the server 1510. In another embodiment, software implementing the systems and methods described herein can be stored on a storage medium in the computer 1502. Thus, the software can be run from the storage medium in the computer system 1526. Therefore, in this embodiment, the software can be used whether or not computer 1502 is connected to network router 1512. Printer 1508 may be connected directly to computer 1502, in which case, the computer system 1526 can print whether or not it is connected to network router 1512.

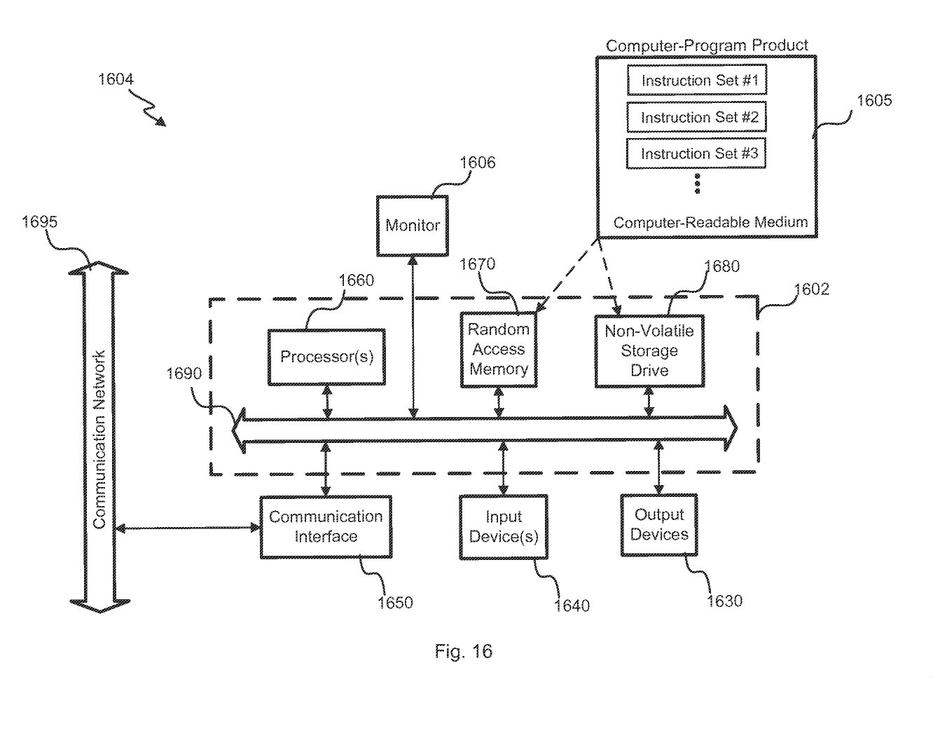

With reference to FIG. 16, an embodiment of a special-purpose computer system 1604 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 626, it is transformed into the special-purpose computer system 1604.

Special-purpose computer system 1604 comprises a computer 1602, a monitor 1606 coupled to computer 1602, one or more additional user output devices 1630 (optional) coupled to computer 1602, one or more user input devices 1640 (e.g., keyboard, mouse, track ball, touch screen) coupled to computer 1602, an optional communications interface 1650 coupled to computer 1602, a computer-program product 1605 stored in a tangible computer-readable memory in computer 1602. Computer-program product 1605 directs system 1604 to perform the above-described methods. Computer 1602 may include one or more processors 1660 that communicate with a number of peripheral devices via a bus subsystem 1690. These peripheral devices may include user output device(s) 1630, user input device(s) 1640, communications interface 1650, and a storage subsystem, such as random access memory (RAM) 1670 and non-volatile storage drive 1680 (e.g., disk drive, optical drive, solid state drive), which are forms of tangible computer-readable memory.

Computer-program product 1605 may be stored in non-volatile storage drive 1680 or another computer-readable medium accessible to computer 1602 and loaded into memory 1670. Each processor 1660 may comprise a microprocessor, such as a microprocessor from Intel® or Advanced Micro Devices, Inc.®, or the like. To support computer-program product 1605, the computer 1602 runs an operating system that handles the communications of product 1605 with the above-noted components, as well as the communications between the above-noted components in support of the computer-program product 1605. Exemplary operating systems include Windows® or the like from Microsoft® Corporation, Solaris® from Oracle®, LINUX, UNIX, and the like.

User input devices 1640 include all possible types of devices and mechanisms to input information to computer system 1602. These may include a keyboard, a keypad, a mouse, a scanner, a digital drawing pad, a touch screen incorporated into the display, audio input devices such as voice recognition systems, microphones, and other types of input devices. In various embodiments, user input devices 1640 are typically embodied as a computer mouse, a trackball, a track pad, a joystick, wireless remote, a drawing tablet, a voice command system. User input devices 1640 typically allow a user to select objects, icons, text and the like that appear on the monitor 1606 via a command such as a click of a button or the like. User output devices 1630 include all possible types of devices and mechanisms to output information from computer 1602. These may include a display (e.g., monitor 1606), printers, non-visual displays such as audio output devices, etc.

Communications interface 1650 provides an interface to other communication networks 1695 and devices and may serve as an interface to receive data from and transmit data to other systems, WANs and/or the Internet. Embodiments of communications interface 1650 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1650 may be coupled to a computer network, to a FireWire® bus, or the like. In other embodiments, communications interface 1650 may be physically integrated on the motherboard of computer 1602, and/or may be a software program, or the like.

RAM 1670 and non-volatile storage drive 1680 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1670 and non-volatile storage drive 1680 may be configured to store the basic programming and data constructs that provide the functionality of various embodiments of the present invention, as described above.

Software instruction sets that provide the functionality of the present invention may be stored in RAM 1670 and non-volatile storage drive 1680. These instruction sets or code may be executed by the processor(s) 1660. RAM 1670 and non-volatile storage drive 1680 may also provide a repository to store data and data structures used in accordance with the present invention. RAM 1670 and non-volatile storage drive 1680 may include a number of memories including a main random access memory (RAM) to store of instructions and data during program execution and a read-only memory (ROM) in which fixed instructions are stored. RAM 1670 and non-volatile storage drive 1680 may include a file storage subsystem providing persistent (non-volatile) storage of program and/or data files. RAM 1670 and non-volatile storage drive 1680 may also include removable storage systems, such as removable flash memory.

Bus subsystem 1690 provides a mechanism to allow the various components and subsystems of computer 1602 communicate with each other as intended. Although bus subsystem 1690 is shown schematically as a single bus, alternative embodiments of the bus subsystem may utilize multiple busses or communication paths within the computer 1602.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. An apparatus for deidentified access of instructional content for testing comprising:
a processor;
a memory device including instructions that, when executed by the processor, cause the processor to:
receive a plurality of test answers to a plurality of test sections in a diagnostic test, wherein:
the diagnostic test diagnoses performance of a user,
the plurality of test sections in the diagnostic test include a first section of a diagnostic test and a second section of a diagnostic test,
the plurality of test answers correspond with the user interacting with the diagnostic test,
the plurality of test answers include a first set of test answers and a second set of test answers,
the first set of test answers corresponds to the first section of the diagnostic test, and
the second set of test answers corresponds to the second section of the diagnostic test;
identify a plurality of correct answers in a key, wherein:
the plurality of correct answers in the key include a first section of correct answers and a second section of correct answers,
the first section of correct answers corresponds with the first section of the diagnostic test, and
the second section of correct answers corresponds with the second section of the diagnostic test;
compare the first set of test answers with the first section of correct answers in the key;
determine a first outcome on the first section of the diagnostic test based in part on the comparison of the first set of test answers, wherein the first outcome identifies one or more correct responses provided in the first section of the diagnostic test;
compare the second set of test answers with the second section of correct answers in the key;
determine a second outcome on the second section of the diagnostic test based in part on the comparison of the second set of test answers, wherein the second outcome identifies one or more correct responses provided in the second section of the diagnostic test;
generate an identifier associated with the user of the diagnostic test, wherein:
the identifier comprises a first portion and a second portion,
the first portion of the identifier indicates the first outcome of the first section of the diagnostic test and the second portion of the identifier indicates the second outcome of the second section of the diagnostic test,
coding of the identifier obscures unaided human interpretation of the first outcome and the second outcome,
the identifier is generated by concatenating the first portion and the second portion in the identifier, and
the identifier uniquely identifies a plurality of instructional content for remediating performance on the diagnostic test; and
transmit the identifier, wherein the identifier uniquely identifies a plurality of instructional content for remediating performance on the diagnostic test; and
an interface, wherein the interface is configured to transmit the identifier via a network.

2. The apparatus for deidentified access of instructional content for testing of claim 1, comprising the processor further configured to:
determine the plurality of instructional content, wherein:
the plurality of instructional content includes a first section of instructional content and a second section of instructional content,
the plurality of instructional content corresponding with the diagnostic test,
the diagnostic test including the first section of the diagnostic test and the second section of the diagnostic test,
receive the identifier associated with the user of the diagnostic test;
identify a plurality of remediation levels in association with the identifier, wherein:
the plurality of remediation levels identifying the remediation needed for the user based in part on the performance on the diagnostic test,
the plurality of remediation levels include a first level of remediation and a second level of remediation,
the first level of remediation corresponds with the first section of the diagnostic test, and
the second level of remediation corresponds with the second section of the diagnostic test;
determine the first section of instructional content in association with the first level of remediation, wherein the first section of instructional content is identified for remediating performance on the first section of the diagnostic test;
determine the second section of instructional content in association with the second level of remediation, wherein the second section of instructional content is identified for remediating performance on the second section of the diagnostic test; and
display the plurality of instructional content.

3. The apparatus for deidentified access of instructional content for testing of claim 1, wherein the identifier is encrypted before the identifier is transmitted.

4. The apparatus for deidentified access of instructional content for testing of claim 1, further comprising:
generate feedback that identifies the performance of the user; and
transmit the feedback.

5. The apparatus for deidentified access of instructional content for testing of claim 4, wherein the feedback includes at least one psychographic illustration depicting the performance of the user.

6. The apparatus for deidentified access of instructional content for testing of claim 4, wherein the feedback includes at least one human-readable description associated with the performance of the user.

7. A method for deidentified access of instructional content for testing comprising:
receiving, by a computing device, a plurality of test answers to a plurality of test sections in a diagnostic test, wherein:
the diagnostic test diagnoses performance of a user,
the plurality of test sections in the diagnostic test include a first section of the diagnostic test and a second section of the diagnostic test,
the plurality of test answers correspond with the user interacting with the diagnostic test,
the plurality of test answers include a first set of test answers and a second set of test answers,
the first set of test answers corresponds to the first section of the diagnostic test, and
the second set of test answers corresponds to the second section of the diagnostic test;
identifying, by the computing device, a plurality of correct answers in a key, wherein:
the plurality of correct answers in the key include a first section of correct answers and a second section of correct answers,
the first section of correct answers corresponds with the first section of the diagnostic test, and
the second section of correct answers corresponds with the second section of the diagnostic test;
comparing the first set of test answers with the first section of correct answers in the key;
determining, by the computing device, a first outcome on the first section of the diagnostic test based in part on the comparison of the first set of test answers, wherein the first outcome identifies one or more correct responses provided in the first section of the diagnostic test;
comparing the second set of test answers with the second section of correct answers in the key;
determining a second outcome on the second section of the diagnostic test based in part on the comparison of the second set of test answers, wherein the second outcome identifies one or more correct responses provided in the second section of the diagnostic test;
generating, by the computing device, an identifier associated with the user of the diagnostic test, wherein:
the identifier comprises a first portion and a second portion,
the first portion of the identifier indicates the first outcome of the first section of the diagnostic test and the second portion of the identifier indicates the second outcome of the second section of the diagnostic test,
coding of the identifier obscures unaided human interpretation of the first outcome and the second outcome,
the identifier is generated by concatenating the first portion and the second portion in the identifier, and
the identifier uniquely identifies a plurality of instructional content for remediating performance on the diagnostic test; and
transmitting the identifier, wherein the identifier uniquely identifies a plurality of instructional content for remediating performance on the diagnostic test.

8. The method for deidentified access of instructional content for testing of claim 7, further comprising:
determining the plurality of instructional content, wherein:
the plurality of instructional content includes a first section of instructional content and a second section of instructional content,
the plurality of instructional content corresponding with a diagnostic test,
the diagnostic test including the first section of the diagnostic test and the second section of the diagnostic test,
receiving the identifier associated with the user of the diagnostic test;
identifying a plurality of remediation levels in association with the identifier, wherein:
the plurality of remediation levels identifying the remediation needed for the user based in part on the performance on the diagnostic test,
the plurality of remediation levels include a first level of remediation and a second level of remediation,
the first level of remediation corresponds with the first section of the diagnostic test, and
the second level of remediation corresponds with the second section of the diagnostic test;
determining the first section of instructional content in association with the first level of remediation, wherein the first section of instructional content is identified for remediating performance on the first section of the diagnostic test;
determining the second section of instructional content in association with the second level of remediation, wherein the second section of instructional content is identified for remediating performance on the second section of the diagnostic test; and
displaying the plurality of instructional content.

9. The method for deidentified access of instructional content for testing of claim 7, wherein the identifier is encrypted before the identifier is transmitted.

10. The method for deidentified access of instructional content for testing of claim 7, further comprising:
generating feedback that identifies the performance of the user; and
transmitting the feedback.

11. The method for deidentified access of instructional content for testing of claim 10, wherein the feedback includes at least one psychographic illustration depicting the performance of the user.

12. The method for deidentified access of instructional content for testing of claim 10, wherein the feedback includes at least one human-readable description associated with the performance of the user.

13. An apparatus for deidentified access of instructional content for testing comprising:
a processor;
a memory device including instructions that, when executed by the processor, cause the processor to:
determine a plurality of instructional content, wherein:
the plurality of instructional content includes a first section of instructional content and a second section of instructional content,
the plurality of instructional content corresponding with a diagnostic test,
the diagnostic test diagnosing performance of a user,
the diagnostic test including a first section of the diagnostic test and a second section of the diagnostic test,
receive an identifier associated with the user of the diagnostic test, wherein:
the identifier comprises a first portion and a second portion,
the first portion of the identifier indicates a first outcome of the first section of the diagnostic test and the second portion of the identifier indicates a second outcome of the second section of the diagnostic test,
coding of the identifier obscures unaided human interpretation of the first outcome and the second outcome,
the identifier is generated by concatenating the first portion and the second portion in the identifier, and
the identifier uniquely identifies the plurality of instructional content for remediating performance on the diagnostic test; and
identify a plurality of remediation levels in association with the identifier, wherein:
the plurality of remediation levels identifying the remediation needed for the user based in part on the performance on the diagnostic test,
the plurality of remediation levels include a first level of remediation and a second level of remediation,
the first level of remediation corresponds with the first section of the diagnostic test, and
the second level of remediation corresponds with the second section of the diagnostic test;
determine the first section of instructional content in association with the first level of remediation, wherein the first section of instructional content is identified for remediating performance on the first section of the diagnostic test;
determine the second section of instructional content in association with the second level of remediation, wherein the second section of instructional content is identified for remediating performance on the second section of the diagnostic test; and
display the plurality of instructional content; and
an interface, wherein the interface is configured to receive the identifier via a network.

14. The apparatus for deidentified access of instructional content for testing claim 13, further comprising instructions that, when executed by the processor, cause the processor to:
receive a plurality of test answers to a plurality of test sections in the diagnostic test, wherein:
the plurality of test sections in the diagnostic test include a first section of the diagnostic test and a second section of the diagnostic test,
the plurality of test answers correspond with the user interacting with the diagnostic test,
the plurality of test answers include a first set of test answers and a second set of test answers,
the first set of test answers corresponds to the first section of the diagnostic test, and
the second set of test answers corresponds to the second section of the diagnostic test;
identify a plurality of correct answers in a key, wherein:
the plurality of correct answers in the key include a first section of correct answers and a second section of correct answers,
the first section of correct answers corresponds with the first section of the diagnostic test, and
the second section of correct answers corresponds with the second section of the diagnostic test;
compare the first set of test answers with the first section of correct answers in the key;
determine a first outcome on the first section of the diagnostic test based in part on the comparison of the first set of test answers, wherein the first outcome identifies one or more correct responses provided in the first section of the diagnostic test;
compare the second set of test answers with the second section of correct answers in the key;
determine a second outcome on the second section of the diagnostic test based in part on the comparison of the second set of test answers, wherein the second outcome identifies one or more correct responses provided in the second section of the diagnostic test;
generate the identifier associated with the user of the diagnostic test; and
transmit the identifier, wherein the identifier uniquely identifies the plurality of instructional content for remediating performance on the diagnostic test.

15. The apparatus for deidentified access of instructional content for testing claim 13, wherein the identifier includes a check portion, wherein the check portion confirms that the identifier is provided correctly.

16. The apparatus for deidentified access of instructional content for testing claim 13, further comprising instructions that, when executed by the processor, cause the processor to:
before the plurality of remediation levels are identified in association with the identifier, decrypt the identifier.

17. The apparatus for deidentified access of instructional content for testing claim 13, wherein the plurality of instructional content includes one or more questions directed to improving the performance of the user.

18. The apparatus for deidentified access of instructional content for testing claim 13, further comprising instructions that, when executed by the processor, cause the processor to:
receive an access code associated with the user of the diagnostic test, wherein the access code indicates a payment to access the plurality of instructional content; and
authenticate the access code before displaying the plurality of instructional content.

19. The apparatus for deidentified access of instructional content for testing claim 18, wherein the payment is provided by a government agency on behalf of the user.

20. The apparatus for deidentified access of instructional content for testing claim 18, wherein the payment is provided by the user.
